(19) United States
(12) Patent Application Publication
(10) Pub. No.: US 2026/0003366 A1
(43) Pub. Date: Jan. 1, 2026

(54) TRAVEL CONTROL SYSTEM AND TRAVEL CONTROL METHOD FOR PARTICULAR MOBILE BODY

(71) Applicant: Hitachi, Ltd., Tokyo (JP)

(72) Inventors: Shintaro SUZUKI, Tokyo (JP); Akihiko HYODO, Tokyo (JP)

(21) Appl. No.: 19/211,574

(22) Filed: May 19, 2025

(30) Foreign Application Priority Data
Jul. 1, 2024 (JP) 2024-106314

(51) Int. Cl. G05D 1/633; G01C 21/00; G01C 21/20

(52) U.S. Cl. CPC G05D 1/633; G01C 21/206; G01C 21/3804

(57) ABSTRACT

Traveling of a particular mobile body is controlled while the cost of the particular mobile body is kept low. A travel control system for controlling traveling of a particular mobile body that moves in a predetermined range while carrying at least one user includes a sensor terminal removably provided on the particular mobile body, the sensor terminal having a sensor for detecting an object on a route to be followed by the particular mobile body, and a travel controlling apparatus communicably connected to the sensor terminal for generating a travel controlling instruction for moving the particular mobile body to a predetermined location, on the basis of predetermined information including data detected by the sensor and received from the sensor terminal, and inputting the generated travel controlling instruction to the particular mobile body.

### CROSS-REFERENCE TO RELATED APPLICATION

The present application claims priority from Japanese application JP2024-106314, filed on Jul. 1, 2024, the content of which is hereby incorporated by reference into this application.

### BACKGROUND OF THE INVENTION

### 1. Field of the Invention

The present invention relates to a travel control system and a travel control method for a particular mobile body.

### 2. Description of the Related Art

In recent years, there have been proposed small and light low-speed mobile bodies called personal mobility vehicles for better convenience of short-distance travel in facilities such as airports and urban areas. Mobile bodies for use in such particular environments are often free of sensors and information processors for enabling themselves to realize autonomous traveling. There has been known a technology for using data captured by cameras mounted on mobile bodies (see U.S. Patent Application Publication No. 2020/0250441, U.S. Patent Application Publication No. 2021/0287548, U.S. Pat. No. 11,378,413, and JP-2022-185369-A).

### SUMMARY OF THE INVENTION

According to the technologies disclosed in the above related-art documents, sensors having fixed technical specifications are secured in advance to the body of a vehicle, and the traveling of the vehicle is controlled using those secured sensors. Hence, if the technologies disclosed in the above related-art documents are applied to the autonomous travelling of a particular object, the manufacturing cost of the particular object increases.

It is an object of the present invention to provide a travel control system and a travel control method for controlling the traveling of a particular mobile body while keeping the cost of the particular mobile body low.

In order to solve the above problem, there is provided according to an aspect of the present invention a travel control system for controlling traveling of a particular mobile body that moves in a predetermined range while carrying at least one user includes a sensor terminal removably provided on the particular mobile body, the sensor terminal having a sensor for detecting an object on a route to be followed by the particular mobile body, and a travel controlling apparatus communicably connected to the sensor terminal for generating a travel controlling instruction for moving the particular mobile body to a predetermined location, on the basis of predetermined information including data detected by the sensor and received from the sensor terminal, and inputting the generated travel controlling instruction to the particular mobile body.

According to the present invention, the travel controlling apparatus can detect an object on the route to be followed by the particular mobile body by use of the sensor of the sensor terminal that is removably provided on the particular mobile body and can control the particular mobile body to move to the predetermined location.

### BRIEF DESCRIPTION OF THE DRAWINGS

FIG. 1 is a schematic view, partly in block form, of a travel control system for a particular mobile body;

FIG. 2 is a schematic plan view illustrating the manner in which a plurality of particular mobile bodies are moving along with pedestrians in a predetermined range;

FIG. 3 is a block diagram of the travel control system;

FIG. 4 is a schematic plan view illustrating a comparative example in which the detection distance of sensors is short;

FIG. 5 is a schematic plan view illustrating an example in which the speed of a particular mobile body is reduced in a case where the detection distance of sensors is short;

FIG. 6 is a schematic plan view illustrating another comparative example in which the viewing angle of a sensor is narrow;

FIG. 7 is a schematic plan view illustrating an example in which a route is adjusted depending on whether the viewing angle of sensors is narrow or wide;

FIG. 8 is a schematic plan view illustrating an example in which the detection range of a sensor terminal varies depending on the horizontal position of the sensor terminal;

FIG. 9 is a schematic plan view illustrating an example in which the detection range of a sensor terminal varies depending on the vertical position of the sensor terminal;

FIG. 10 is a schematic side elevational view illustrating an example in which the positional relation between sensor terminals and a particular mobile body is specified;

FIG. 11 is a schematic side elevational view illustrating another example in which the positional relation between sensor terminals and a particular mobile body is specified;

FIG. 12 is a schematic view illustrating a process of dynamically managing map information in a predetermined range;

FIG. 13 is a diagram illustrating an example of tables managed by a control profile managing section;

FIG. 14 is a flowchart of a terminal controlling process;

FIG. 15 is a flowchart of a calibration process;

FIG. 16 is a flowchart of a self-position transmitting process;

FIG. 17 is a flowchart of an obstacle detecting process;

FIG. 18 is a flowchart of a profile generating process;

FIG. 19 is a flowchart of a profile updating process;

FIG. 20 is a flowchart of a route planning process;

FIG. 21 is a flowchart of a travel controlling process;

FIG. 22 is a diagram illustrating a terminal profile according to a second embodiment of the present invention;

FIG. 23 is a diagram illustrating another terminal profile;

FIG. 24 is a flowchart of a terminal controlling process;

FIG. 25 is a flowchart of a travel controlling process;

FIG. 26 is a schematic plan view illustrating the manner in which a route to be followed by a particular mobile body can be shortened by orienting a sensor on the particular mobile body into a direction in which the particular mobile body is turned in a case where the viewing angle of the sensor is narrow;

FIG. 27 is a view illustrating the manner in which the user is instructed which direction the sensor terminal is to be oriented in;

FIG. 28 is a block diagram of a travel control system according to a third embodiment of the present invention;

FIG. 29 is a diagram illustrating a mobile body profile;

FIG. 30 is a flowchart of a process of performing communication with the user according to a fourth embodiment of the present invention;

FIG. 31 is a schematic view, partly in block form, of a travel control system according to a fifth embodiment of the present invention;

FIG. 32 is a schematic view, partly in block form, illustrating an example in which an augmented reality/virtual reality (AR/VR) goggle is used as a sensor terminal according to a sixth embodiment of the present invention;

FIG. 33 is a schematic plan view illustrating the manner in which a particular mobile body performs self-position estimation while exchanging data detected by sensors with a nearby particular mobile body according to a seventh embodiment of the present invention;

FIG. 34 is a block diagram of a travel control system;

FIG. 35 is a sequence diagram illustrating a process of exchanging data detected by sensors between nearby particular mobile bodies and transmitting information concerning calculated self-positions and obstacles to a travel controlling apparatus; and

FIG. 36 is a schematic plan view illustrating the manner in which a two-seater particular mobile body increases its detection range by orienting sensor terminals carried by front and rear users on the two-seater particular mobile body in different directions, according to an eight embodiment of the present invention.

### DESCRIPTION OF THE PREFERRED EMBODIMENTS

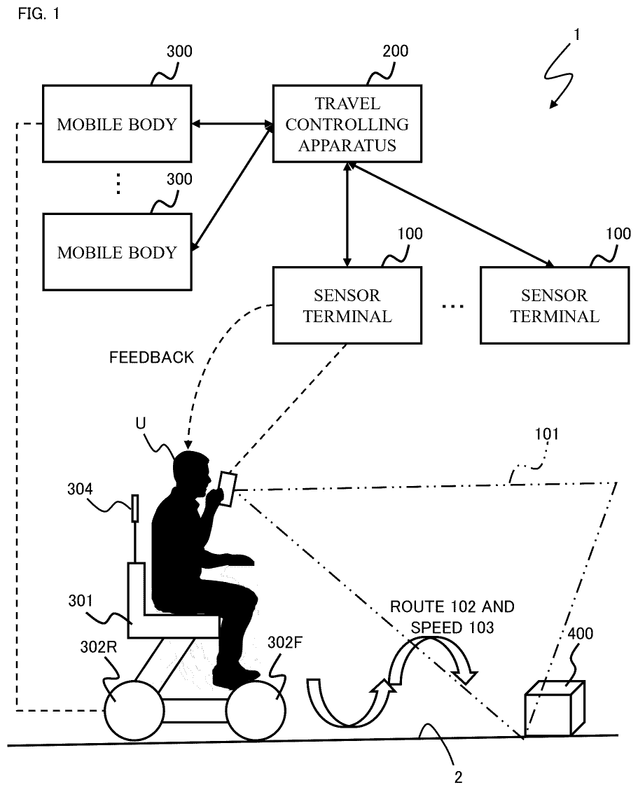

Preferred embodiments of the present invention will be described hereinbelow with reference to the accompanying drawings. FIG. 1 schematically illustrates, partly in block form, a travel control system 1 according to the present invention that controls autonomous traveling of the particular mobile body 300 by using a spatial recognition ability of a sensor terminal 100 that a user U on the particular mobile body 300 is carrying. In other words, the particular mobile body 300 itself is not required to have sensors for autonomous traveling.

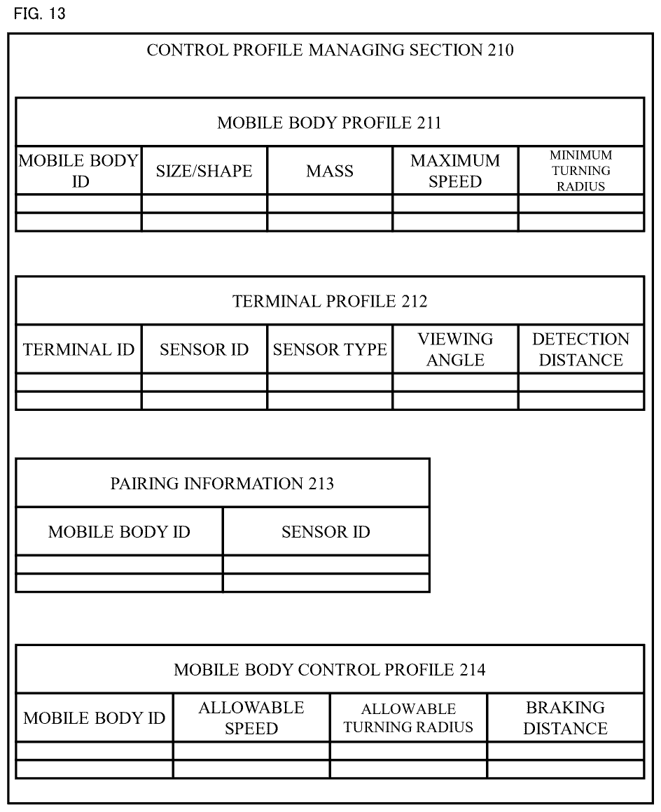

The particular mobile body 300 according to the present invention is used for movement within predetermined ranges, e.g., airports, amusement parks, hospitals, factories, harbors, various facilities, residential areas, business districts, and urban areas, and has such features having a small size, a light weight, and a low speed. Usually, the particular mobile body 300 is a one seater or two seater. The particular mobile body 300 is in the form of an electric chair, an electric trolley, a motor-assisted bicycle, or an electric scooter, for example. The particular mobile body 300 according to the present invention is not limited to having any numbers of wheels and any drive systems. A plurality of particular mobile bodies 300 that travel within a predetermined range may have different technical specifications. Insofar as a profile, i.e., a mobile body control profile 214 to be described later with reference to FIG. 13, of particular mobile bodies 300 is known, particular mobile bodies 300 having different technical specifications may travel within one predetermined range. For example, different particular mobile bodies, e.g., a one-seater particular mobile body, a two-seater particular mobile body, and a particular mobile body for carrying a large cart, may exist together in a predetermined range.

The sensor terminal 100 according to the present invention refers to an information processing terminal carried by the user U, for example. The sensor terminal 100 has a spatial recognition ability to detect an object 400 on a route to be followed by the particular mobile body 300, an information processing ability to calculate information regarding the detected object 400 and estimating a self-position, i.e., its own position of the sensor terminal 100, and a communication ability to exchange information with a travel controlling apparatus 200. The sensor terminal 100 may be a portable information terminal owned by the user U, for example.

According to the present invention, the portable information terminal refers to, for example, a mobile phone (including what is generally called a smartphone) or a portable personal computer. The portable information terminal is in the form of a tablet, a notebook, a wrist watch, a pair of glasses, or a pair of goggles, for example. Since the portable information terminal is a device carried by the user U that uses the particular mobile body 300, different portable information terminals often have no identical technical specifications, but different technical specifications. The technical specifications include information indicative of the ability of sensors that are incorporated in the sensor terminal 100. The ability of the sensors includes, for example, a viewing angle that indicates how wide its detection range is and a detection distance that indicates how far it can detect. The information processing ability and/or the communication ability of the sensor terminal 100 may be included in the technical specifications.

Note that the sensor terminal 100 is not limited to the portable information terminal. The sensor terminal 100 may be an information processing terminal as long as it has the spatial recognition ability, the information processing ability, and the communication ability described above.

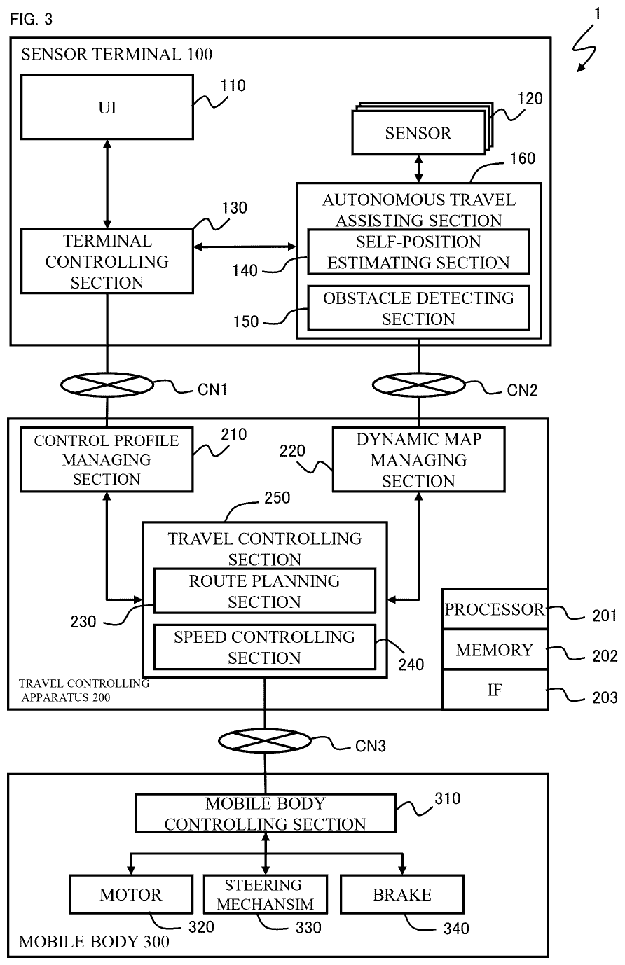

The travel controlling apparatus 200 refers to a computer that is communicably linked to the sensor terminal 100. For example, the travel controlling apparatus 200 includes hardware resources such as a processor 201, a memory 202, and an interface 203 (see FIG. 3).

The travel controlling apparatus 200 generates a travel control instruction for instructing the particular mobile body 300 to move to a predetermined place, on the basis of predetermined information including detected sensor data received from the sensor terminal 100, and inputs the generated travel control instruction to the particular mobile body 300. The travel control instruction includes, for example, a route 102 along which the particular mobile body 300 is to move to the predetermined place and a speed 103 at which the particular mobile body 300 is to move. In addition to the route 102 and the speed 103, the travel control instruction may further include a turning radius for turning movement of the particular mobile body 300. As described later, the turning radius may be adjusted to be longer or shorter for allowing the particular mobile body 300 to travel autonomously with safety along a route of limited visibility.

The travel controlling apparatus 200 can send predetermined feedback information regarding the position and the posture of the sensor terminal 100 from the sensor terminal 100 to the user U. Moreover, the travel controlling apparatus 200 can calculate a possibility that the user U will comply with the feedback information and correct the travel control instruction according to the calculated possibility. Further, the travel controlling apparatus 200 may include a dynamic map managing section for generating and updating a map within a predetermined range on the basis of predetermined information.

The travel controlling apparatus 200 may be configured as a server separate from the sensor terminal 100 and the particular mobile body 300. The travel controlling apparatus 200 that is configured as an independent apparatus communicates with the sensor terminal 100 and the particular mobile body 300. Alternatively, the travel controlling apparatus 200 may be incorporated in the sensor terminal 100 or may be provided in the particular mobile body 300.

The travel controlling apparatus 200 that is configured as a server manages movement of a plurality of particular mobile bodies 300 within a predetermined range such as an airport or a business district, for example. The travel controlling apparatus 200 that is incorporated in the sensor terminal 100 is linked with the sensor terminal 100 and controls autonomous traveling of the particular mobile body 300 on which the user U rides carrying the sensor terminal 100. The travel controlling apparatus 200 that is provided in the particular mobile body 300 is linked with the particular mobile body 300 and controls autonomous traveling of the particular mobile body 300, by using data from the sensor terminal 100 carried by the user U riding on the particular mobile body 300. As described later, a plurality of sensor terminals 100 that exist within a range capable of short-distance communication can share data detected by their sensors by way of short-distance communication.

As described above, the travel controlling apparatus 200 that is provided in a particular mobile body 300 basically handles autonomous traveling of only that particular mobile body 300. However, the travel controlling apparatus 200 that is provided in either one of a plurality of particular mobile bodies 300 may act as a master travel controlling apparatus and handle part or all of autonomous traveling of the other particular mobile bodies 300 within a communicable range.

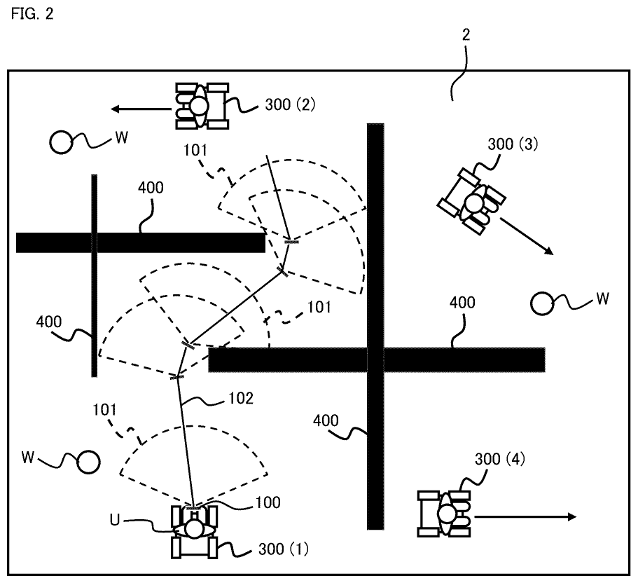

The object 400 refers to an object positioned on the route to be followed by the particular mobile body 300. For example, the object 400 may be any of various structures such as a building wall, a door, a utility pole, a guardrail, a handrail, steps, an escalator, an elevator, a trash can, a bench, and any figure and a pedestrian W (see FIG. 2). The pedestrian W may accompany a cart or a pet.

According to the present invention configured as described above, the sensors of the sensor terminal 100 held by the user U can be used as sensors for detecting data required for the particular mobile body 300 to travel autonomously. As the particular mobile body 300 is free of its own sensors secured thereto, the manufacturing cost and the maintenance cost of the particular mobile body 300 are lower than if a particular mobile body 300 has sensors secured thereto.

The travel control system 1 according to the present invention uses sensor terminals 100 carried by respective users U, and the sensor terminals 100 have various technical specifications. The travel control system 1 is able to control autonomous traveling of the particular mobile bodies 300 in view of the differences between sensor characteristics of the sensor terminals 100. A particular mobile body 300 or particular mobile bodies 300 may hereinafter be abbreviated to a “mobile body 300” or “mobile bodies 300.”

### First Embodiment

A first embodiment of the present invention will be described below with reference to FIGS. 1 through 21. FIG. 1 schematically illustrates, partly in block form, a travel control system 1 for a particular mobile body 300 according to a first embodiment of the present invention. As described above, the travel control system 1 uses a sensor terminal 100 held by a user U that moves using a mobile body 300 and controls autonomous traveling of the mobile body 300, by using information detected by sensors of the sensor terminal 100.

The travel control system 1 includes at least one sensor terminal 100, at least one travel controlling apparatus 200, and at least one mobile body 300, for example. The travel controlling apparatus 200 may be incorporated in the mobile body 300 or the sensor terminal 100. A predetermined range in which the mobile body 300 moves may be managed by one travel controlling apparatus 200. Alternatively, the predetermined range may be divided into a plurality of zones, the mobile body 300 that travels in the zones may be controlled by travel controlling apparatuses 200 disposed in the respective zones, and the travel controlling apparatuses 200 in the respective zones may collaborate with each other.

The mobile body 300 includes a vehicle body 301, a front wheel 302F mounted on a front lower portion of the vehicle body 301, a rear wheel 302R mounted on a rear lower portion of the vehicle body 301, and a positioning marker 304, for example. In addition, the mobile body 300 may include, for example, a steering mechanism, arm rests, and an illuminating device for illuminating an area ahead of the mobile body 300, all not illustrated. The numbers of the front wheel 302F and the rear wheel 302R do not matter. The mobile body 300 may be a one-wheel, two-wheel, three-wheel, or four-wheel mobile body. The mobile body 300 may move by actuating a rubber crawler track or by alternately moving a plurality of legs. The mobile body 300 is not limited to any particular types of moving systems and drive sources.

The mobile body 300 includes the positioning marker 304. The marker 304 is printed with a two-dimensional code, for example. The location of the marker 304 on the mobile body 300 is known. For example, an inner camera of the sensor terminal 100 captures an image of the two-dimensional code of the marker 304, and the captured image is analyzed to specify the positional relation (including a posture) between the sensor terminal 100 and the mobile body 300.

The position of the sensor terminal 100 in a predetermined range such as a facility or a business district, for example, can be specified by a global positioning system (GPS) incorporated in the sensor terminal 100. The position of the sensor terminal 100 can also be specified from the relation between the surrounding scenery captured by an outer camera of the sensor terminal 100 and structures on a map. Further, the position of the mobile body 300 can also be specified from a positional information detector such as the GPS, the speed of the mobile body 300, the direction of travel of the mobile body 300, and the length of time for which the mobile body 300 has moved. Any of these processes may be used. In a case where the mobile body 300 moves in a facility such as an airport, the position of the mobile body 300 can also be specified by detecting the positions and directions of various structures such as billboards, columns, advertisements, walls, entrances, and exits in the facilities and distances up to those structures. Further, communication units for short-distance communication may be installed at predetermined sites in the facility, and some of the communication units and the sensor terminal 100 may communicate with each other to calculate the position of the sensor terminal 100.

The sensor terminal 100 is a portable information terminal owned by the user U, such as a smartphone, for example, as described above.

The user U activates an application program installed in the sensor terminal 100, makes a reservation for the use of the mobile body 300, and goes out to a boarding area selected with the application program, for example.

As described in detail later, the user U performs pairing between the mobile body 300 waiting at the boarding area and the sensor terminal 100, to unlock the mobile body 300, and gets on the mobile body 300. Then, the user U captures an image of the marker 304 with the inner camera of the sensor terminal 100 and performs positioning of the mobile body 300.

When the user U indicates a destination with the application program in the sensor terminal 100, the mobile body 300 automatically starts moving along a route and at a speed (also a turning radius) calculated by the travel controlling apparatus 200. While the mobile body 300 is in motion, the user U orients the sensor terminal 100 in a predetermined direction according to feedback information from the travel controlling apparatus 200. The user U keeps orienting the sensor terminal 100 held by hand in the direction indicated by the travel controlling apparatus 200. Alternatively, the mobile body 300 may have a robot arm that holds the sensor terminal 100, and the position and the posture of the robot arm may be controlled by an instruction from the travel controlling apparatus 200, as described later.

The sensors, denoted by 120 in FIG. 3, of the sensor terminal 100 capture an image of an area ahead of the sensor terminal 100 and detect an object 400 in a detection range 101. The object 400 may be a structure such as a wall on the route 102 along which the particular mobile body 300 is moving, another mobile body 300 on a floor 2, a bench, a utility pole, or a trash can, for example. However, the object 400 is not limited to an inorganic object, and may be a pedestrian, a security guard, a sales clerk, or a pet, for example. The object 400 can be defined as an obstacle that may possibly obstruct the traveling of the mobile body 300.

FIG. 2 schematically illustrates in plan the manner in which a plurality of mobile bodies 300 are moving along with pedestrians W in a predetermined range. There are structures 400 such as walls on the floor 2, with passages or squares present therebetween. The passages are shared by a plurality of mobile bodies 300(1) through 300(3) and a plurality of pedestrians W.

As illustrated in FIG. 2, the mobile body 300(1) moves along the route 102 determined by the travel controlling apparatus 200 at the speed 103 (see FIG. 1) determined by the travel controlling apparatus 200 while detecting the object 400 in the detection range 101 in front of the mobile body 300(1) in the direction in which the mobile body 300(1) travels. The travel controlling apparatus 200 gives the user U feedback information regarding autonomous traveling of the mobile body 300, prompting the user U to adjust the orientation of the sensor terminal 100. When the mobile body 300 enters a corner, the mobile body 300 makes a turn according to an instruction from the travel controlling apparatus 200.

The mobile bodies 300 and other objects (the pedestrians W) that use the floor 2 share the floor 2 and freely move thereon. The mobile body 300 does not travel on roadways and sideways that are clearly defined, and is often used in environments where the mobile body 300 and the pedestrians W coexist.

FIG. 3 illustrates in block form the travel control system 1. FIG. 3 depicts one sensor terminal 100, one travel controlling apparatus 200, and one mobile body 300. The sensor terminal 100 and the mobile body 300 are held in a one-to-one correspondence, as described above. One travel controlling apparatus 200 may control autonomous traveling of a plurality of mobile bodies 300. As described later, a plurality of sensor terminals 100 may be associated with one mobile body 300. It is possible to use sensor terminals 100, travel controlling apparatuses 200, and mobile bodies 300 in other combinations.

The sensor terminal 100 includes a user interface 110, a plurality of sensors 120, a terminal controlling section 130, and an autonomous travel assisting section 160, for example.

The user interface 110 includes a monitor display, a touch panel, a microphone, and a speaker, for example, and refers to a device for exchanging information with the user U. In FIG. 3, the user interface is abbreviated to “UI.”

The sensors 120 refer to a group of sensors including, for example, a front camera, a rear camera, a three-dimensional (3D) camera, a luminance sensor, an acceleration sensor, a gyro sensor, a magnetic sensor, a biometric authentication sensor, and a light detection and ranging (LiDAR) sensor.

The terminal controlling section 130 controls operation of the sensor terminal 100. The autonomous travel assisting section 160 includes a self-position estimating section 140 for estimating the self-position of the sensor terminal 100 and an obstacle detecting section 150 for detecting an obstacle. The autonomous travel assisting section 160 refers to an application program downloaded from an unillustrated application distribution server and installed into the sensor terminal 100. In FIG. 3, the terminal controlling section 130 and the autonomous travel assisting section 160 are separately illustrated. In practice, however, a processor in the terminal controlling section 130 executes an application program installed in a memory thereof to realize the autonomous travel assisting section 160.

The self-position estimating section 140 estimates the position of the sensor terminal 100. Specifically, the self-position estimating section 140 estimates the current position of the sensor terminal 100 on the basis of data from the cameras included in the sensors 120 or a GPS and transmits the estimated position to the travel controlling apparatus 200.

The obstacle detecting section 150 detects a front obstacle (object) 400 on the basis of data detected by the sensors 120 and transmits the detected result to the travel controlling apparatus 200. The detected result includes the position, shape, and size of the obstacle. The object 400 may also be referred to as the “obstacle 400.”

The functional details of the travel controlling apparatus 200 will be described below. The travel controlling apparatus 200 includes a computer including hardware resources such as a processor 201, a memory 202, and various interfaces 203, for example. The memory 202 stores therein predetermined computer programs for performing functions 210, 220, 230, 240, and 250, to be described below, of the travel controlling apparatus 200. The processor 201 executes the predetermined computer programs to perform the functions of the travel controlling apparatus 200.

A control profile managing section 210 acquires and manages technical specifications of the sensor terminal 100 and technical specifications of the mobile body 200. These items of information that are managed by the control profile managing section 210 will be described later with reference to FIG. 13.

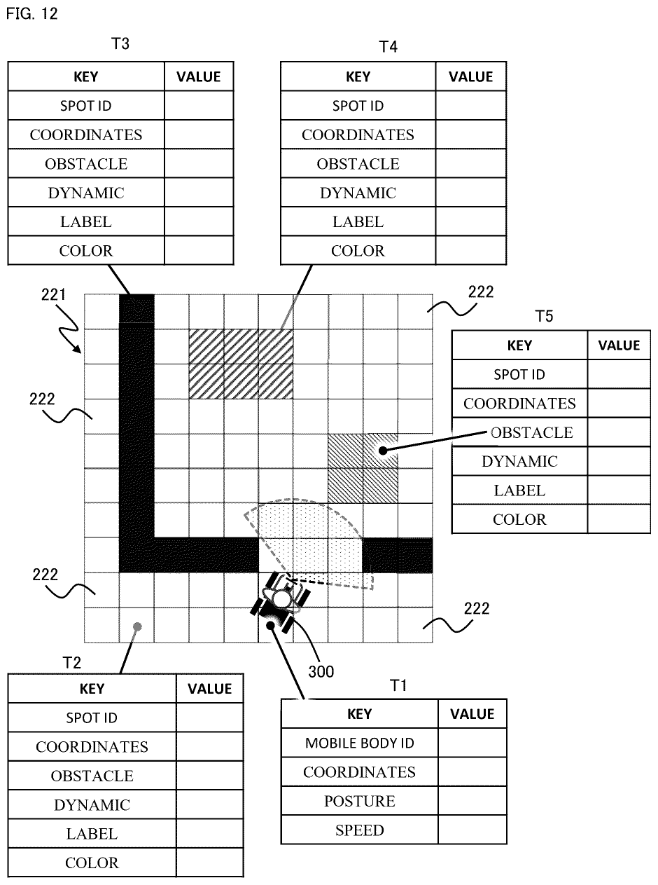

A dynamic map managing section 220 generates and updates map information 221 (see FIG. 12) in a predetermined range in which the mobile body 300 travels. The map information 221 that is handled by the dynamic map managing section 220 includes basic map information representing a structural diagram of a facility or a map of a business district, for example. The dynamic map managing section 220 recognizes the presence of a dynamic object (e.g., a pedestrian or a piece of furniture) that could be changed in position, on the basis of information (self-position information and detected obstacle information) from each sensor terminal 100 associated with each mobile body 300, and updates the map information 221. The more the mobile body 300 travels in the predetermined range, the higher the accuracy of the map information 221 in the predetermined range becomes. The map information may hereinafter be abbreviated to “map” in some cases.

A travel controlling section 250 transmits a travel controlling instruction to the mobile body 300. The travel controlling instruction represents information for controlling autonomous travel of the mobile body 300. The travel controlling instruction includes the route 102 and the speed 103. The travel controlling instruction may also include a turning radius, for example.

The travel controlling section 250 includes a route planning section 230 and a speed controlling section 240, for example. The route planning section 230 plans the route 102 along which the mobile body 300 is to travel. The speed controlling section 240 determines the speed 103 at which the mobile body 300 is to travel.

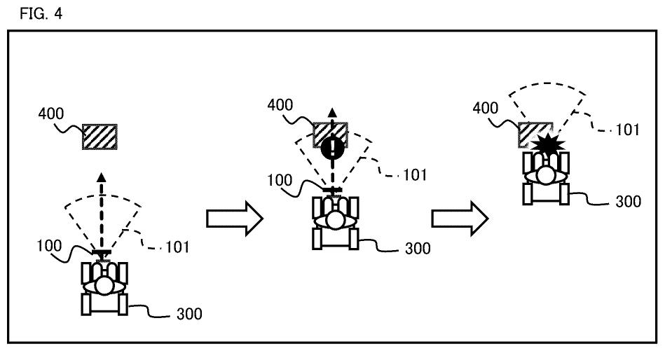

The route 102 includes an overall route along which the mobile body 300 is to move from a departure site to a destination and routes in zones that are included in the overall route. The route planning section 230 appropriately updates the route 102 on the basis of the position and the speed of the mobile body 300, the position of the obstacle 400, the distance up to the obstacle 400, and the size of the detection range 101 of the sensor terminal 100, for example. Examples of processes of generating the route 102 will be described later with reference to FIGS. 4 through 7.

The mobile body 300 autonomously travels in the predetermined range while carrying the user U. The mobile body 300 includes a mobile body controlling section 310, a motor 320, a steering mechanism 330, and a brake 340, for example. Although not illustrated, the mobile body 300 may also include a light and a battery. The mobile body controlling section 310 receives a travel controlling instruction from the travel controlling apparatus 200 and controls such drive mechanisms as the motor 320, the steering mechanism 330, and the brake 340 according to the received travel controlling instruction to enable the mobile body 300 to travel.

FIG. 4 schematically illustrates a comparative example in which the detection range 101 of a sensor 120 of a sensor terminal 100 is small, i.e., the detection distance is short. In FIG. 4, the mobile body 300 starts to travel straight, as illustrated on the left. Then, the mobile body 300 recognizes the presence of an obstacle 400 while traveling, as illustrated at the center, and tries to stop, as illustrated on the right. The detection distance and the viewing angle of the sensors 120 are included in the information that has been acquired in advance from the sensor terminal 100 by the travel controlling apparatus 200.

If the detection distance of the sensors 120 is equal to or smaller than the braking distance of the mobile body 300 (detection distance≤braking distance), then even when the travel controlling apparatus 200 detects the obstacle 400 on the route to be followed by the mobile body 300 and applies the brake 340, as illustrated on the center, the mobile body 300 fails to stop in front of the obstacle 400 and may possibly collide with the obstacle 400, as illustrated on the right.

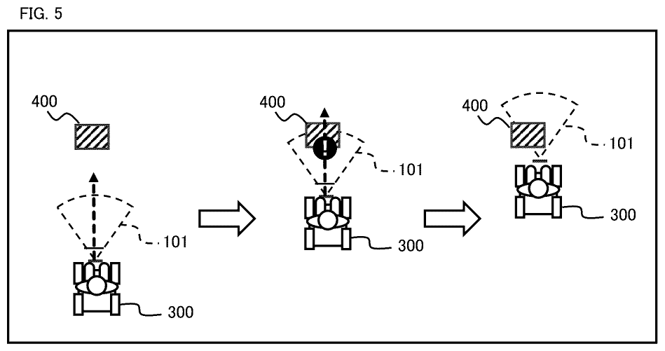

FIG. 5 schematically illustrates an example in which the speed of the mobile body 300 is lowered in a case where the detection distance of a sensor 120 of the sensor terminal 100 is short. In FIG. 5, as in FIG. 4, the mobile body 300 starts to travel straight, as illustrated on the left. Then, the mobile body 300 recognizes the presence of an obstacle 400 while traveling, as illustrated at the center, and tries to stop, as illustrated on the right.

In the example illustrated in FIG. 5, the speed of the mobile body 300 is reduced to a level lower than the speed of the mobile body 300 in the example illustrated in FIG. 4. This is because the detection distance of the sensor 120 of the sensor terminal 100 cannot be increased. Hence, the travel controlling apparatus 200 reduces the speed of the mobile body 300 depending on the value of the detection distance of the sensor 120. The mobile body 300 is thus able to stop without colliding with the obstacle 400.

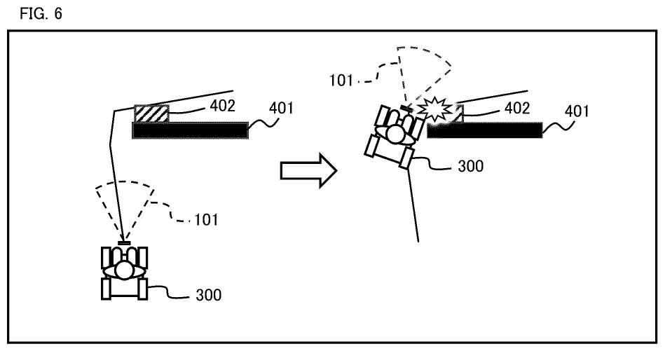

FIG. 6 schematically illustrates another comparative example in which the viewing angle of a sensor 120 of a sensor terminal 100 is wide. In FIG. 6, the mobile body 300 is to travel past a side edge of a known object 401 as illustrated on the left, and tries to go around behind the object 401, as illustrated on the right.

If the viewing angle of the sensor 120 is sufficiently wide, then even when an unknown obstacle 402, e.g., a luggage or a tool, is left behind a known object 401, e.g., a structure such as a wall, the travel controlling apparatus 200 can detect the obstacle 402 and control the mobile body 300 to stop before colliding with the obstacle 402. However, if the viewing angle of the sensor 120 is narrow, as illustrated in FIG. 6, the mobile body 300 tends to be late with detecting the obstacle 402 behind the object 401 while trying to go around behind the object 401. The mobile body 300 is thus unable to stop in time and may possibly collide with the unknown obstacle 402.

The position of the unknown obstacle 402 is detected by the obstacle detecting section 150 of the sensor terminal 100 and is transmitted to the travel controlling apparatus 200. According to the notification from the sensor terminal 100, the dynamic map managing section 220 updates the map of the predetermined range. The updated map is shared by the sensor terminals 100 of other mobile bodies 300 that are traveling in the predetermined range.

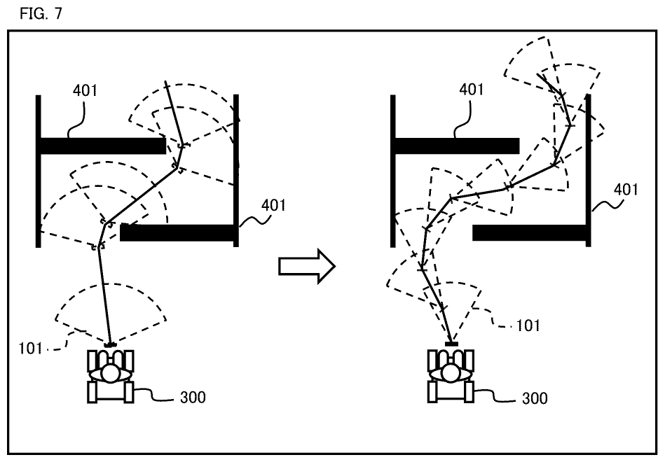

FIG. 7 schematically illustrates an example in which a route is adjusted depending on whether the viewing angle of a sensor 120 of a sensor terminal 100 is narrow or wide. In FIG. 7 on the left, the viewing angle of the sensor 120 is wide. In this case, the travel controlling apparatus 200 calculates a shortest route even along sharp curves formed by a known structure 401. In FIG. 7 on the right, the viewing angle of the sensor 120 is narrow. In this case, the travel controlling apparatus 200 calculates a route that includes curves having reduced turning radii and hence is longer than the route illustrated in FIG. 7 on the left. The narrower the viewing angle of the sensor 120 is, the shorter the length of each of zones included in the route becomes, and the longer the period of time required for the mobile body 300 to travel becomes.

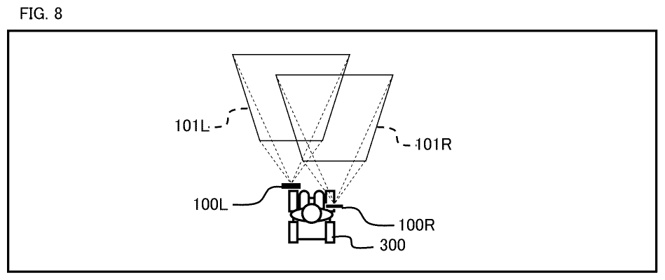

An outline of the relation between the positions and detection ranges of sensor terminals 100 and the positioning of the sensor terminals 100 and the mobile body 300 with respect to each other will be described below with reference to FIGS. 8 through 11.

FIG. 8 schematically illustrates in plan an example in which the detection range of a sensor terminal 100 varies depending on the horizontal position of the sensor terminal 100. As illustrated in FIG. 8, a detection range 101L of a sensor terminal 100 held by the user U with its left hand is different from a detection range 101R of a sensor terminal 100 held by the user U with its right hand.

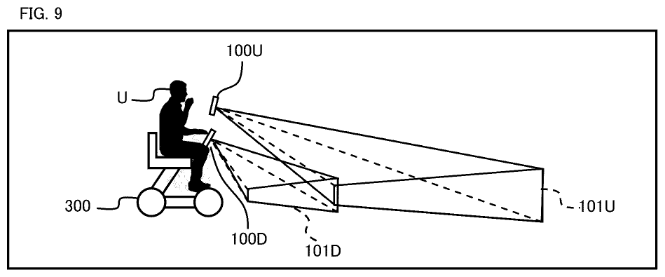

FIG. 9 schematically illustrates in side elevation an example in which the detection range of a sensor terminal 100 varies depending on the vertical position of the sensor terminal 100. As illustrated in FIG. 9, when the user U raises the sensor terminal 100 to a higher position, its detection range 101U extends to a far position, but the sensor terminal 100 fails to detect a nearby object. Conversely, when the user U lowers the sensor terminal 100, its detection range 100D covers a nearby area in which the sensor terminal 100 can detect a nearby object, but the sensor terminal 100 fails to detect a far object.

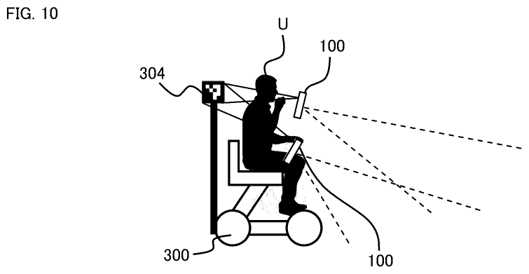

FIG. 10 schematically illustrates in side elevation an example in which the positional relation between sensor terminals 100 and a mobile body 300 is specified. As illustrated in FIG. 10, providing the marker 304 is placed in a relatively high position behind the user U, the rear camera of the sensor terminal 100 is able to capture an image of the marker 304 irrespective of whether the sensor terminal 100 is held in a high position or a low position. The printed two-dimensional code on the marker 304 in the captured image is analyzed to specify the positional relation between the sensor terminal 100 (including its posture) and the mobile body 300.

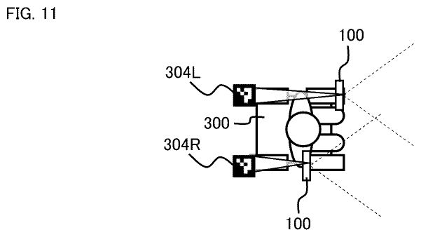

FIG. 11 schematically illustrates in plan another example in which the positional relation between sensor terminals 100 and a mobile body 300 is specified. The mobile body 300 includes markers 304L and 304R behind respective left and right sides of the mobile body 300. Regardless of whether the user U holds the sensor terminal 100 on the left side or the user U holds the sensor terminal 100 on the right side, either one of the sensor terminals 100 can capture an image of the two-dimensional code of the positioning marker 304 to specify the positional relation between the mobile body 300 and the sensor terminals 100.

According to the examples illustrated in FIGS. 10 and 11, providing the markers 304 are placed in relatively high positions behind the respective left and right sides of the mobile body 300, even when the user U holds the sensor terminal 100 with the left hand, the user U holds the sensor terminal 100 with the right hand, the user U holds the sensor terminal 100 at a relatively high position, or the user U holds the sensor terminal 100 at a relatively low position, the positional relation between the mobile body 300 and the sensor terminals 100 can be specified. Instead of the examples illustrated in FIGS. 10 and 11, the marker or markers 304 may alternatively be placed in a position or positions where the positional relation between the mobile body 300 and the sensor terminal or terminals 100 can be specified.

FIG. 12 schematically illustrates a process of dynamically managing the map information 221 in the predetermined range. The map information 221 that is dynamically managed is formed in a mesh pattern and includes a plurality of grids 222. The dynamic map managing section 220 assigns information to each of the grids 222 to express an area where the mobile body 300 can travel. The grids 222 or objects on the grids 222 are managed by tables T1 through T5. The grids 222 may be expressed in a two-dimensional space or a three-dimensional space.

In order to express the shape of an obstacle accurately, finer grids 222 may be set. Conversely, in order to plan routes efficiently, coarser grids 222 may be set. Alternatively, the size of grids 222 may be varied depending on the area where the mobile body 300 can travel.

The map information 221 may be represented by a group of spots indicative of a distribution of obstacles, rather than the mesh grid. The dynamic map managing section 220 may manage the shape and the coordinate information of obstacles separately, and may dynamically manage only the coordinate information. Moreover, the dynamic map managing section 220 manages, in the map information 221, the positions, the postures, and the speeds of mobile bodies 300 and the sensor terminals 100 in superposed relation to ranges 101 where obstacles can be detected by the sensors 120 of the sensor terminals 100.

The dynamically managing process illustrated in FIG. 12 will be described in detail below. An object representing a mobile body 300 on grids 222 is associated with a mobile body managing table T1. The mobile body managing table T1 contains data for managing the position and other attributes of the mobile body 300 in the map information 221. The mobile body managing table T1 manages certain keys such as “MOBILE BODY ID,” “COORDINATES,” “POSTURE,” and “SPEED,” for example. “MOBILE BODY ID” represents information that identifies the mobile body 300 in the travel control system 1. “COORDINATES” represents the current position of the mobile body 300. “POSTURE” represents the orientation of the mobile body 300. “SPEED” represents the speed of travel of the mobile body 300.

Each of the grids 222 is associated with a grid managing table T2. The grid managing table T2 contains keys such as “SPOT ID,” “COORDINATES,” “OBSTACLE,” “DYNAMIC,” “LABEL,” and “COLOR” and their values.

“SPOT ID” represents information specifying a place that corresponds to the grid 222. “COORDINATES” represents the position of the grid 222. “OBSTACLE” represents whether an object 400 is present or not. “DYNAMIC” represents whether an object 440 present in the grid 222 is dynamic or not. For example, a pedestrian or a piece of furniture is movable and hence is a dynamic object. A part of a building such as a wall, an entrance, or an exit is usually unmovable and hence is not a dynamic object.

The travel control system 1 according to the present embodiment is capable of continuously updating the map information 221 that varies from time to time, with use of sensor terminals 100 associated with a plurality of mobile bodies 300 that are traveling in the predetermined range. The latest map information 221 thus updated can be shared by the sensor terminals 100.

“LABEL” represents an object type that is indicative of an object 400 on grids 222. Various object types include pieces of furniture such as a wall and a figure and a human, for example. “COLOR” represents the color of the surface of an object 400 on grids 222. The self-position of the sensor terminal 100 can correctly be estimated by clearly identifying an object 400 such as a wall fixedly positioned in the predetermined range, on the basis of its position, shape, size, and color.

A table T3 illustrated as an upper left inset in FIG. 12 manages a grid 222 where an object 400 such as a wall is placed, for example. A table T4 illustrated as an upper right inset in FIG. 12 manages a grid 222 where a dynamic object 400 such as a figure is placed, for example. A table T5 illustrated as a central right inset in FIG. 12 manages a grid 222 where a dynamic object 400 such as a human is placed.

The mobility of an object 400 may be managed in a plurality of levels. For example, since a human or an animal changes its position in a relatively short period of time, its mobility is set to a higher level. Since a piece of furniture such as a figure or a stepladder, though it can be moved, tends to stay in position longer than pedestrians, its mobility is set to a lower level. Grids 222 where objects with higher mobility levels are placed have their situations highly likely to vary with time, the travel controlling apparatus 200 can take into account the presence of grids 222 where objects that are easily movable are placed in calculating a route.

FIG. 13 illustrates an example of tables managed by the control profile managing section 210. The control profile managing section 210 manages tables including a mobile body profile 211, a terminal profile 212, pairing information 213, and a mobile body control profile 214.

The mobile body profile 211 stores items of information inherent in each mobile body 300, such as an identification (ID), a size/shape, mass, a maximum speed, and a minimum turning radius. The mobile body profile 211 may be of such a format as a unified robotics description format (URDF).

The terminal profile 212 stores items of information inherent in each sensor of the sensor terminal 100, such as a terminal ID, a sensor ID, a sensor type, a viewing angle, and a detectable distance. These items of information may be design values acquired via the operating system (OS) of the sensor terminal 100 or values measured when the sensor terminal 100 and the travel controlling apparatus 200 are paired.

The pairing information 213 manages items of information of each mobile body 300 that link the mobile body 300 and the sensor terminal 100 that is used to control the mobile body 300.

The mobile body control profile 214 stores items of information of each mobile body 300 such as an allowable speed, an allowable turning radius, and a braking distance. These items of information are calculated from the mobile body profile 211, the terminal profile 212, and the pairing information 213 that links the mobile body profile 211 and the terminal profile 212. The stored contents of the mobile body control profile 214 dynamically vary depending on combinations and positional relations between sensor terminals 100 and mobile bodies 300.

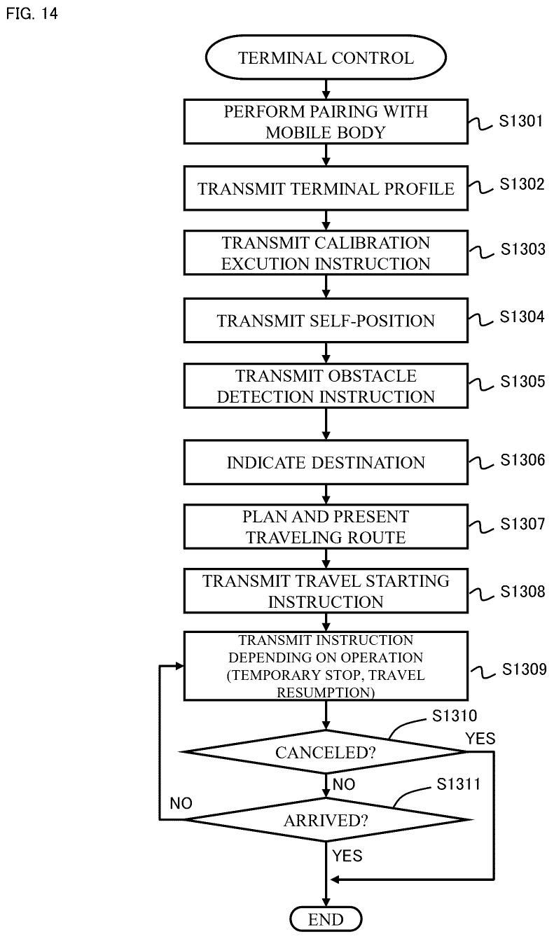

FIG. 14 is a flowchart of a terminal controlling process carried out by the terminal controlling section 130. When the sensor terminal 100 is activated, it performs pairing with the mobile body 300 (S1301). In a case where there are a plurality of mobile bodies 300 available for use, the sensor terminal 100 performs pairing with a selected one of the mobile bodies 300.

A mobile body 300 to be paired is selected by the user U via the user interface 110 or selected by a sensor 120 of the sensor terminal 100 that reads the marker 304 of the mobile body 300. Information regarding the selected mobile body 300 is transmitted from the sensor terminal 100 to the control profile managing section 210 of the travel controlling apparatus 200. The control profile managing section 210 generates pairing information 213 that associates the selected mobile body 300 and the sensor 120 of the sensor terminal 100.

The terminal controlling section 130 acquires the terminal profile 212 and transmits the acquired terminal profile 212 to the control profile managing section 210 (S1302). The terminal profile 212 may be design values acquired via the OS of the sensor terminal 100. The terminal controlling section 130 may measure the ability of the sensor 120 of the sensor terminal 100 by having the sensor 120 read a particular pattern and transmit a measured ability value to the control profile managing section 210 where it is stored in the terminal profile 212.

The terminal controlling section 130 transmits a calibration execution instruction to instruct the user interface 110 and the self-position estimating section 140 to execute a calibration process (S1303). The calibration process refers to a process of estimating the positions and the postures in a space of the sensor terminal 100 and the mobile body 300.

After the calibration process is completed, the terminal controlling section 130 transmits a self-position transmission starting instruction to instruct the self-position estimating section 140 to start transmit a self-position (S1304) and then transmits an obstacle detection instruction to instruct the obstacle detecting section 150 to start detecting an obstacle (S1305).

The terminal controlling section 130 receives a destination indicated by the user U from the user interface 110 and indicates the received destination to the route planning section 230 of the travel controlling apparatus 200 (S1306).

When the terminal controlling section 130 receives information concerning a target route 102 generated by the route planning section 230, the terminal controlling section 130 transmits the information concerning the target route 102 to the user interface 110, presenting the planned traveling route 102 to the user U (S1307).

When the terminal controlling section 130 receives a travel starting instruction from the user interface 110, the terminal controlling section 130 transmits the received travel starting instruction to the travel controlling section 250 to instruct the travel controlling section 250 to start autonomous travel of the mobile body 300 (S1308).

The terminal controlling section 130 enters a standby state waiting for an input from the user interface 110 or the travel controlling section 250 and transmits an instruction depending on the content of input (S1309).

If the input represents a temporary stop instruction or a travel resumption instruction, then the terminal controlling section 130 sends the temporary stop instruction or the travel resumption instruction to the travel controlling section 250 and enters the standby state again.

If the terminal controlling section 130 receives an instruction to cancel the autonomous traveling from the user interface 110 or the travel controlling apparatus 200 (S1310: YES), then the terminal controlling section 130 cancels the traveling of the mobile body 300, after which the processing sequence is ended.

If the terminal controlling section 130 receives information indicating that the mobile body 300 has arrived at the destination from the travel controlling apparatus 200 (S1311: YES), then the terminal controlling section 130 sends an arrival notification to the user interface 110, after which the processing sequence comes to an end.

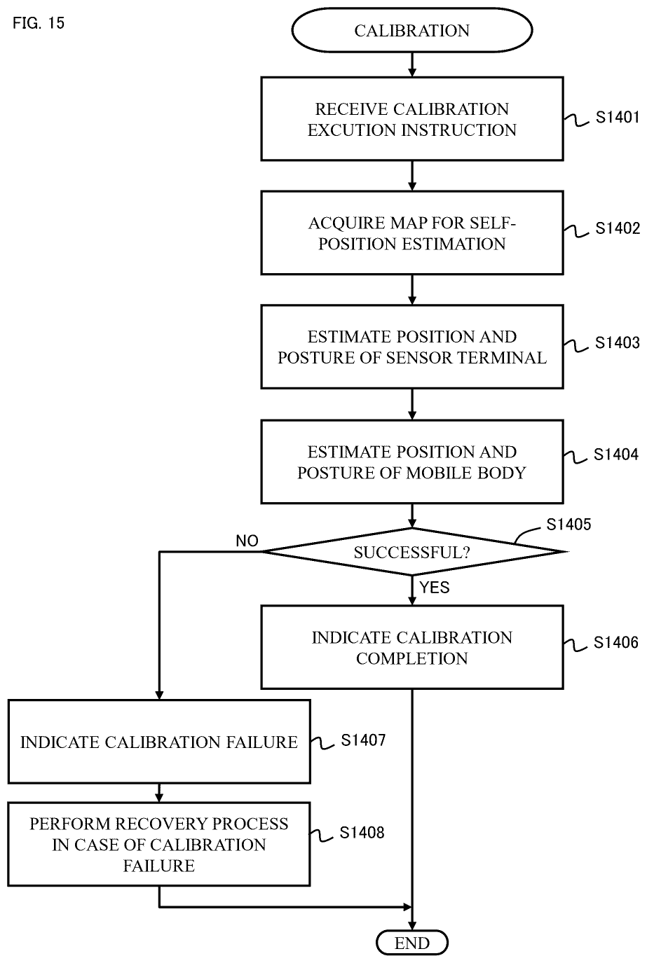

FIG. 15 is a flowchart of the calibration process carried out by the self-position estimating section 140.

The calibration process begins when the self-position estimating section 140 receives the calibration execution instruction (see S1303 in FIG. 14) from the terminal controlling section 130 (S1401).

The self-position estimating section 140 acquires map information for estimating the self-position from the dynamic map managing section 220 (S1402). The map information acquired by the self-position estimating section 140 includes, for example, three-dimensional obstacle information (spot group) for self-position estimation from the LiDAR sensor and color information for self-position estimation from the cameras.

The self-position estimating section 140 estimates the current position and posture of the sensor terminal 100 in a space on the basis of the map information and information measured by the sensors 120 of the sensor terminal 100 (S1403). Further, the self-position estimating section 140 estimates the position and posture of the mobile body 300 in the space on the basis of information concerning the position and the posture of the sensor terminal 100 in the space and information concerning the position and the posture, acquired by the inner camera, of the marker 304 with respect to the sensor terminal 100 (S1404).

The self-position estimating section 140 then determines whether its estimation of the positions and the postures of the sensor terminal 100 and the mobile body 300 has been successful or not (S1405).

If the estimation by the self-position estimating section 140 of the positions and the postures of the sensor terminal 100 and the mobile body 300 has been successful (S1405: YES), then the self-position estimating section 140 indicates the completion of the calibration process to the user interface 110 (S1406), after which the processing sequence is brought to an end.

If the estimation by the self-position estimating section 140 of the positions and postures of the sensor terminal 100 and the mobile body 300 has failed (S1405: NO), then the self-position estimating section 140 indicates the failure of the calibration process to the user interface 110 (S1407).

In a case where the calibration process has failed, the self-position estimating section 140 may perform a recovery process (S1408). In the recovery process, the self-position estimating section 140 outputs a message “SET CAMERA IN PREDETERMINED POSITION AND ORIENT IN PREDETERMINED DIRECTION” or controls the user interface 110 to display the position and the posture to be taken by the camera. If the calibration process fails while the mobile body 300 is traveling, then the self-position estimating section 140 decelerates the mobile body 300 to a stop and controls the user interface 110 to indicate to the user U that the calibration process needs to be performed again. In a case where the position and the posture of the sensor terminal 100 have become temporarily unknown, the mobile body 300 may travel automatically on the basis of the latest position and posture of the sensor terminal 100 and the latest speed of the mobile body 300.

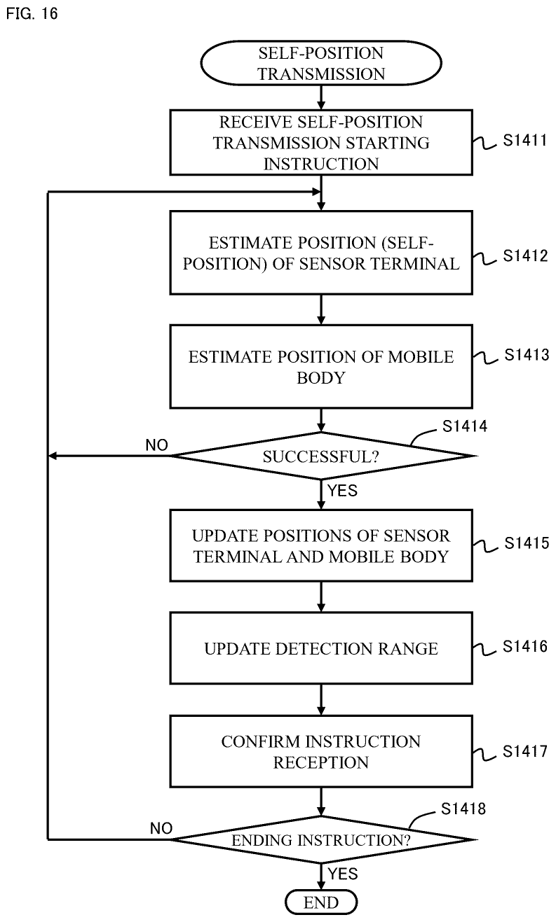

A self-position transmitting process performed by the self-position estimating section 140 will be described below with reference to FIG. 16. The self-position estimating section 140 begins the self-position transmitting process when it receives the self-position transmission starting instruction (see S1304 in FIG. 14) from the terminal controlling section 130 (S1411).

The self-position estimating section 140 estimates a self-position of the sensor terminal 100 in a space by using measured information from the sensors 120 (S1412) and then estimates the position of the mobile body 300 (S1413).

The self-position estimating section 140 determines whether its estimation of the self-position of the sensor terminal 100 and the position of the mobile body 300 has been successful or not (S1414). If the self-position estimating section 140 decides that the estimation has been successful (S1414: YES), then the self-position estimating section 140 transmits the estimated position and posture of the sensor terminal 100 and the estimated position and posture of the mobile body 300 to the obstacle detecting section 150 and the dynamic map managing section 220.

The self-position estimating section 140 updates information regarding the detection range 101 in the dynamic map on the basis of the updated position and posture of the sensor terminal 100 (S1416), and transmits the updated detection range 101 to the dynamic map managing section 220.

The self-position estimating section 140 confirms whether it has received an instruction from other functions or not (S1407). If the self-position estimating section 140 has received an ending instruction (S1418: YES), then the processing sequence is ended. If the self-position estimating section 140 has not received an ending instruction or has received an instruction other than an ending instruction (S1418: NO), then the self-position estimating section 140 goes back to step S1412 to repeat the processing from S1412, i.e., the estimation and transmission of the self-position. If the self-position estimating section 140 decides that the estimation has failed (S1414: NO), then the self-position estimating section 140 also goes back to step S1412 to repeat the estimation and transmission of a self-position.

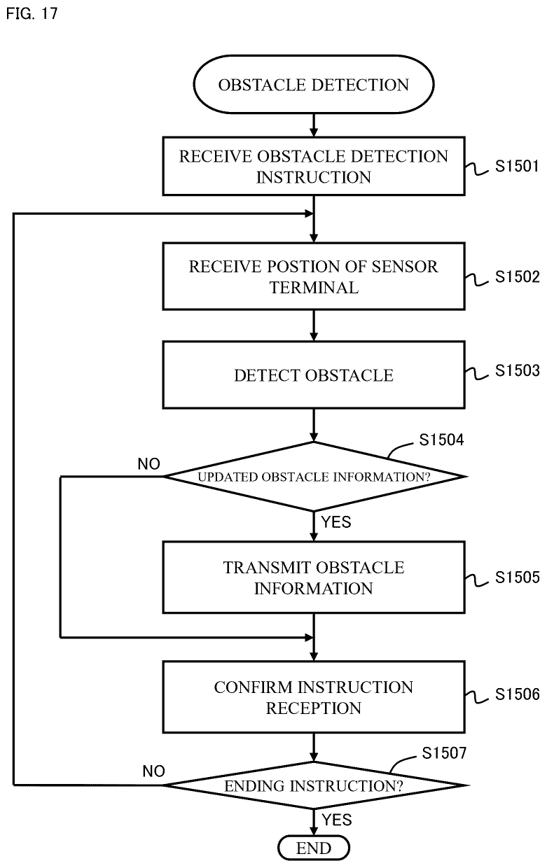

An obstacle detecting process performed by the obstacle detecting section 150 will be described below with reference to FIG. 17. The obstacle detecting section 150 starts to perform the obstacle detecting process when it receives the obstacle detection instruction (see S1305 in FIG. 14) from the terminal controlling section 130 (S1501).

The obstacle detecting section 150 receives information concerning the latest position and posture of the sensor terminal 100 from the self-position estimating section 140 (S1502), checks the received information and the information measured by the sensors 120, determines whether there is an obstacle or not, and, if there is an obstacle, detects the position and shape of the obstacle (S1503).

The obstacle detecting section 150 determines whether obstacle information has been updated or not (S1504). The obstacle information is updated when a new obstacle is detected and when the position or shape of an existing obstacle is varied, for example. If there is updated obstacle information (S1504: YES), then the obstacle detecting section 150 transmits the latest obstacle information to the dynamic map managing section 220 (S1505). If there is no updated obstacle information (S1504: NO), then the obstacle detecting section 150 skips S1505 and goes to step S1506.

The obstacle detecting section 150 confirms whether it has received an instruction from other functions or not (S1506). If the obstacle detecting section 150 has received an ending instruction (S1507: YES), then the processing sequence comes to an end. If the obstacle detecting section 150 has not received an ending instruction or has received an instruction other than an ending instruction (S1507: NO), then the obstacle detecting section 150 goes back to step S1502 to repeat the processing from S1502, i.e., the detection and transmission of an obstacle.

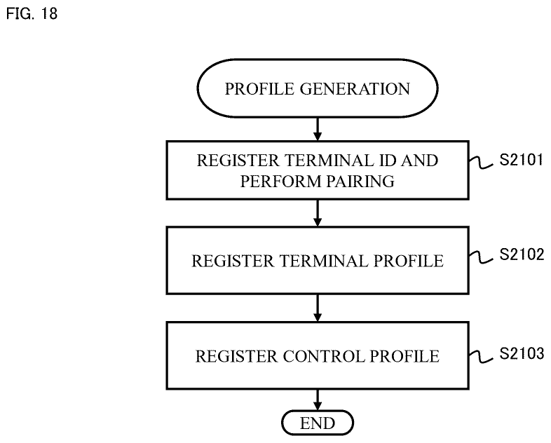

FIG. 18 is a flowchart of a profile generating process performed by the control profile managing section 210. The control profile managing section 210 starts to perform the profile generating process when it receives a pairing instruction (see S1301 in FIG. 14) to pair with the mobile body 300 from the terminal controlling section 130. The control profile managing section 210 registers linking of the sensor terminal 100 and the mobile body 300 in the pairing information 213 (S2101).

The control profile managing section 210 registers the profile of the sensors 120 acquired from the sensor terminal 100 in the terminal profile 212 (S2102). Further, the control profile managing section 210 calculates and registers the mobile body control profile 214 on the basis of the mobile body profile 211 and the terminal profile 212 (S2103), after which the processing sequence comes to an end.

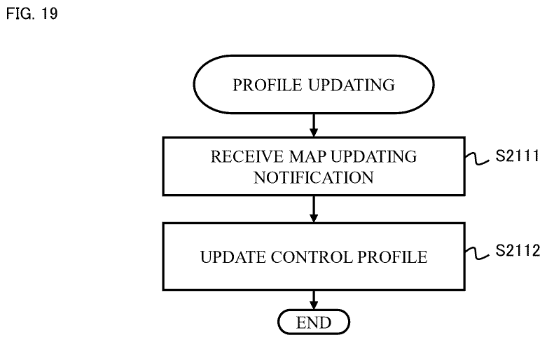

FIG. 19 is a flowchart of a profile updating process performed by the control profile managing section 210.

The control profile managing section 210 starts to perform the profile updating process when it receives a map updating notification for updating the map information 221 from the dynamic map managing section 220 (S2111). The control profile managing section 210 calculates and updates the mobile body control profile 214 on the basis of the latest map information 221, the mobile body profile 211, the terminal profile 212, and the pairing information 213 (S2112).

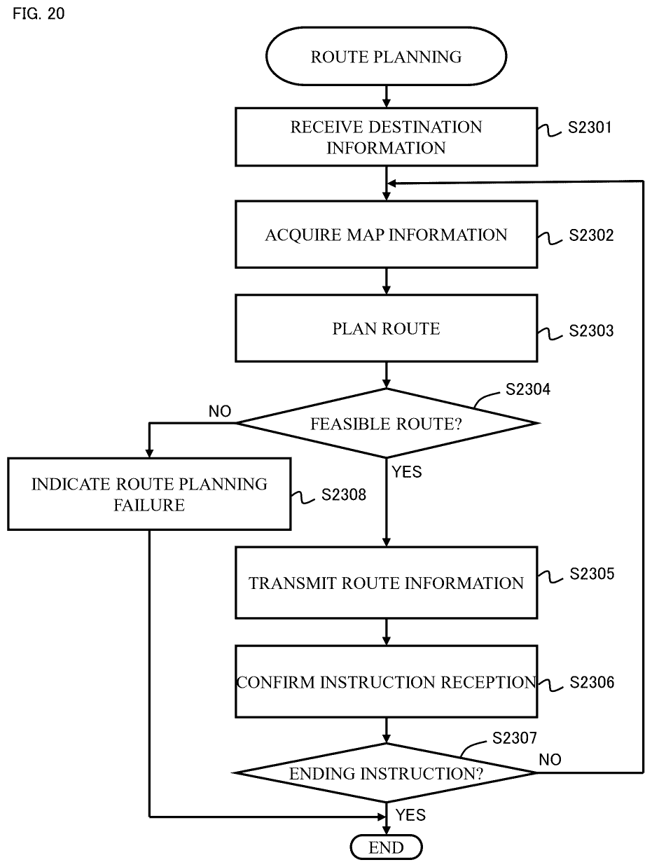

FIG. 20 is a flowchart of a route planning process performed by the route planning section 230. The route planning section 230 begins the route planning process when it receives the indicated destination (S1306 in FIG. 14) from the user interface 110 (S2301).

The route planning section 230 acquires the latest map information 221 from the dynamic map managing section 220 (S2302) and calculates a target route from the current position of the mobile body 300 to the destination (S2303). At this time, the route planning section 230 plans the route within the constraints of an allowable radius of curvature and an allowable speed on the basis of the information regarding the mobile body control profile 214 acquired from the control profile managing section 210.

The route planning section 230 determines whether there is a feasible route along which the destination can be reached within the constraints or not (S2304). If the route planning section 230 can calculate a feasible route (S2304: YES), then the route planning section 230 transmits the route information to the user interface 110 and the travel controlling section 250 (S2305). If there is no feasible route (S2304: NO), then the route planning section 230 transmits a notification indicating a route planning failure to the user interface 110 and the travel controlling section 250 (S2308).

After step S2305, the route planning section 230 confirms whether it has received an instruction from other functions or not (S2306). If the route planning section 230 has received an ending instruction (S2307: YES), then the processing sequence is brought to an end. If the route planning section 230 has not received an ending instruction or has received an instruction other than an ending instruction (S2307: NO), then the route planning section 230 goes back to step S2302 to repeat the processing from S2302, i.e., the planning (or updating) and transmission of a route.

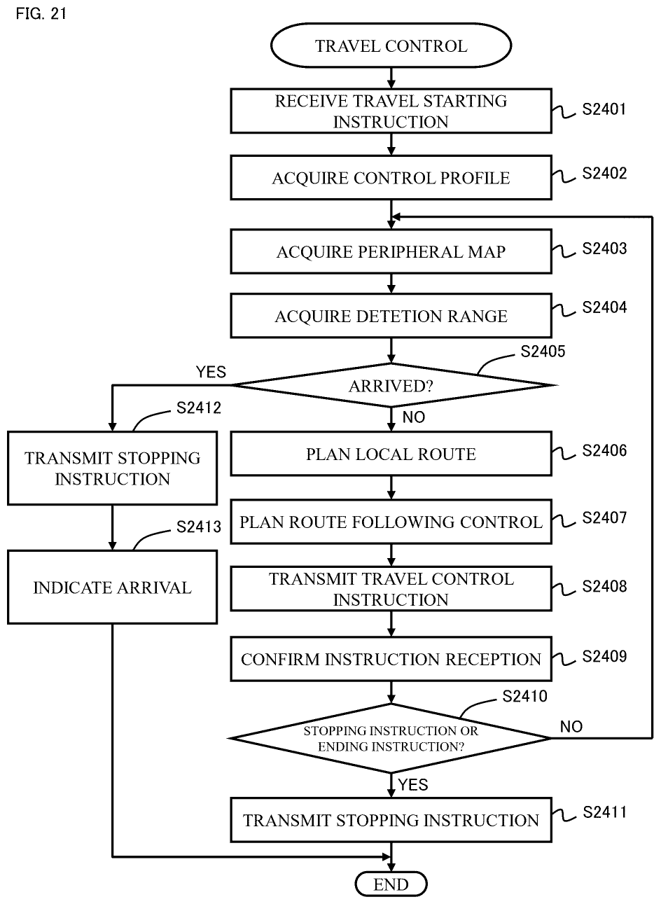

FIG. 21 is a flowchart of a travel controlling process performed by the travel controlling section 250. The travel controlling section 250 starts to perform the travel controlling process when it receives a travel starting instruction (see S1308 in FIG. 14) from the user interface 110 (S2401).

The travel controlling section 250 acquires the control profile of the mobile body 300 from the control profile managing section 210 (S2402). Further, the travel controlling section 250 acquires the latest map information 221 of the periphery of the mobile body 300 from the dynamic map managing section 220 (S2403) and acquires the position of the mobile body 300 in the grid 222 and the detection range 101 detectable by the sensors of the sensor terminal 100 (S2404).

On the basis of the dynamic map information 221 and the position of the mobile body 300 in the grid 222, the travel controlling section 250 determines whether the mobile body 300 has arrived at the destination or not (S2405). If the travel controlling section 250 decides that the mobile body 300 has arrived at the destination (S2405: YES), the travel controlling section 250 transmits a stopping instruction to the mobile body controlling section 310 (S2412) and indicates the arrival of the mobile body 300 at the destination to the user interface 110 (S2413), whereupon the processing sequence comes to an end.

If the travel controlling section 250 decides that the mobile body 300 has not arrived at the destination (S2405: NO), then the travel controlling section 250 receives the latest target route information from the route planning section 230 (see S2305 in FIG. 20) and plans a feasible local target route in view of the map information 221 of the periphery of the mobile body 300 and the detection range 101 (S2406).

The travel controlling section 250 generates a route following control plan for controlling the mobile body 300 to follow the local target route within the constraints of the speed and the turning radius in the mobile body control profile 214 (S2407) and then transmits the generated route following control plan as a travel control instruction to the mobile body controlling section 310 (S2408).

The travel controlling section 250 confirms whether it has received an instruction from other functions or not (S2409). If the travel controlling section 250 has received a stopping instruction or an ending instruction (S2410: YES), then the travel controlling section 250 transmits a stopping instruction to the mobile body controlling section 310 (S2411), whereupon the processing sequence is ended. If the travel controlling section 250 has not received a stopping instruction or an ending instruction or has received an instruction other than a stopping instruction or an ending instruction (S2410: NO), then the travel controlling section 250 goes back to step S2403 to repeat the processing from S2403, i.e., the acquisition of the latest map information 221, the planning of a local route, and the transmission of a travel control instruction. The mobile body 300 eventually arrives at the destination indicated by the user U by continuing to travel along each of local routes that may be planned (S2405).

According to the present embodiment described above, the sensors 120 of the sensor terminal 100 carried by the user U can be used as sensors for detecting data required for the particular mobile body 300 to travel autonomously. As the particular mobile body 300 is free of its own sensors secured thereto, the manufacturing cost and the maintenance cost of the particular mobile body 300 are lower than if a particular mobile body 300 has sensors secured thereto.

The travel control system 1 according to the present embodiment uses sensor terminals 100 carried by respective users U, and the sensor terminals 100 have various technical specifications. The travel control system 1 is able to control autonomous traveling of the particular mobile bodies 300 in view of the differences between sensor characteristics of the sensor terminals 100.

According to the present embodiment, as illustrated in FIGS. 5 and 7, a speed and a turning radius are established for the mobile body 300 depending on the detecting capability (detection range, detection distance), position, and posture of the sensor terminal 100, and a local route 102 is generated on the basis of data from the sensors 120 of the sensor terminal 100. Thus, the mobile body 300 can be controlled to travel autonomously with safety by use of any one of sensor terminals 100 having different technical specifications.

### Second Embodiment

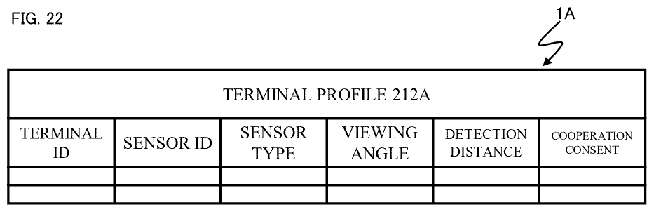

A second embodiment of the present invention will be described below with reference to FIGS. 22 through 27. The second embodiment and other embodiments to be described later will be described mainly with respect to their differences from the first embodiment described above. According to the second embodiment, the posture of the sensor terminal 100 is changed in cooperation with the user to use a sensor having a narrow viewing angle as if it were a sensor having a wide viewing angle.

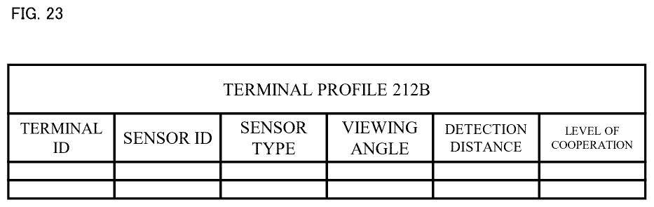

FIG. 22 illustrates a terminal profile 212A that is used by a travel control system 1A according to the second embodiment. FIG. 23 illustrates another terminal profile 212B.

According to the present embodiment, the user U on the mobile body 300 changes the position and the posture of the sensor terminal 100 while the mobile body 300 is traveling according to a predetermined instruction from the sensor terminal 100. For example, even if the sensor terminal 100 includes a sensor having a narrow field of view, the user U is able to obtain control constraints on a sensor having a wider field of view by turning the sensor terminal 100.

To achieve the variable sensor capability, the terminal profile 212A stores an item of information representing how much the user U can follow a predetermined instruction from the sensor terminal 100 to change the position and the posture of the sensor terminal 100.

For example, as illustrated in FIG. 22, the terminal profile 212A stores a cooperation consent flag indicative of whether the user U can cooperate or not. Alternatively, as illustrated in FIG. 23, the terminal profile 212B stores a numerical value indicative of a level of cooperation from the user U. According to the present embodiment, when the terminal profile 212A or 212B is updated, in a case where the cooperation consent flag indicates that the user U can cooperate or the level of cooperation from the user U is high, the constraint of the allowable radius of curvature is eased. Since the user U cooperates in changing the orientation of the sensor terminal 100, a sensor having a narrow field of view in the sensor terminal 100 can be handled as a sensor having a wide field of view.

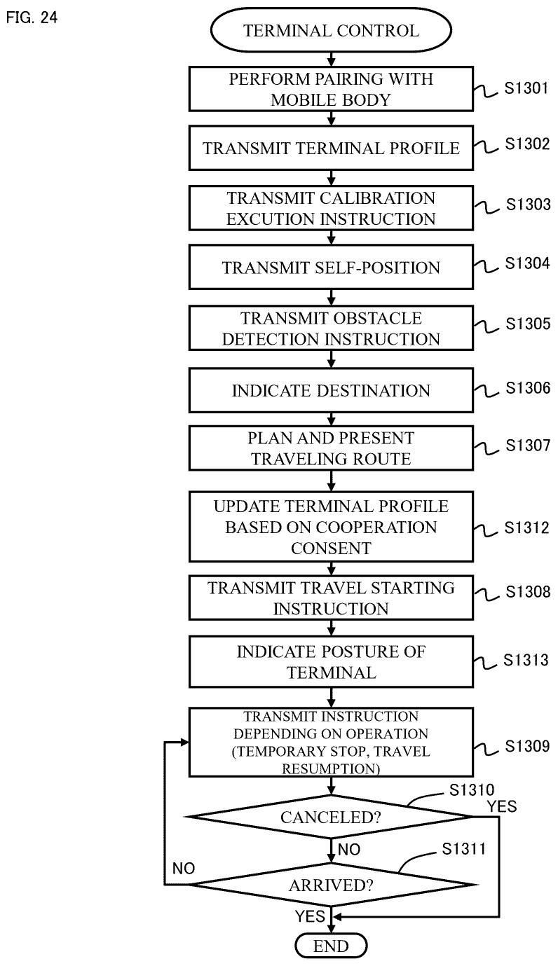

FIG. 24 is a flowchart of a terminal controlling process. The terminal controlling process illustrated in FIG. 24 is different from the terminal controlling process illustrated in FIG. 14 according to the first embodiment in that steps S1312 and S1313 are added.

The terminal controlling section 130 executes step S1312 after step S1307. Step S1312 refers to a process of acquiring how the user U cooperates with a predetermined instruction from the sensor terminal 100 regarding a posture change. Specifically, the terminal controlling section 130 controls the user interface 110 to prompt the user U to select a decision to determine whether to consent to cooperate or a decision to choose a level of cooperation from a plurality of cooperation levels. Then, the terminal controlling section 130 stores an input from the user U regarding its cooperation into the terminal profile 212A or 212B.

At this time, the terminal controlling section 130 may indicate to the user U how a planned route and an arrival time vary depending on whether there is cooperation from the user U or not, thereby persuading the user U to cooperate. The travel controlling apparatus 200 may calculate the planned route and the arrival time and transmit them to the sensor terminal 100. Alternatively, rather than asking the user U to select a level of cooperation in advance, the terminal controlling section 130 may calculate how much the user U has followed the instruction from the sensor terminal 100, on the basis of the sensor data, and store the calculated value into the terminal profile 212A or 212B.

Step S1313 is executed after step S1308. In step S1313, the terminal controlling section 130 indicates the position and the posture of the sensor terminal 100 to the user U on the basis of a posture indication received from the travel controlling section 250. At this time, the terminal controlling section 130 may display the difference between an ideal terminal posture (the position and the posture of the sensor terminal 100) and the current terminal posture on a display of the sensor terminal 100.

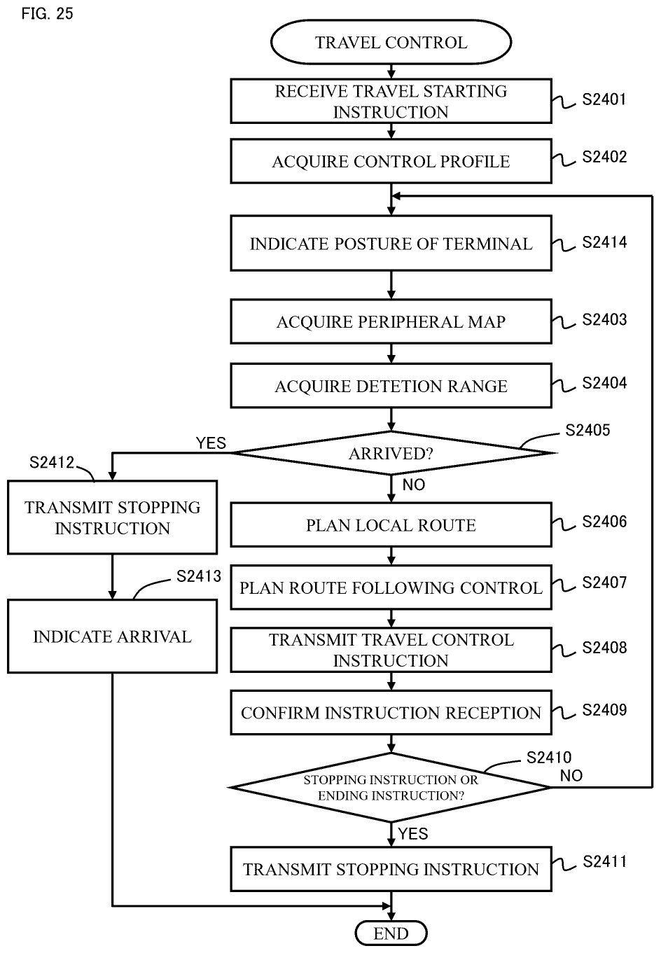

FIG. 25 is a flowchart of a travel controlling process. The travel controlling process illustrated in FIG. 25 is different from the travel controlling process illustrated in FIG. 21 in that step S2414 is added after step S2402.

In step S2414, the travel controlling section 250 calculates a posture of the sensor terminal 100 that is ideal for following the target route and controls the user interface 110 to display the calculated posture. The posture of the sensor terminal 100 that is ideal for following the target route refers to such a posture that the sensor terminal 100 is directed toward a spot that is a constant distance ahead on the target route, for example.

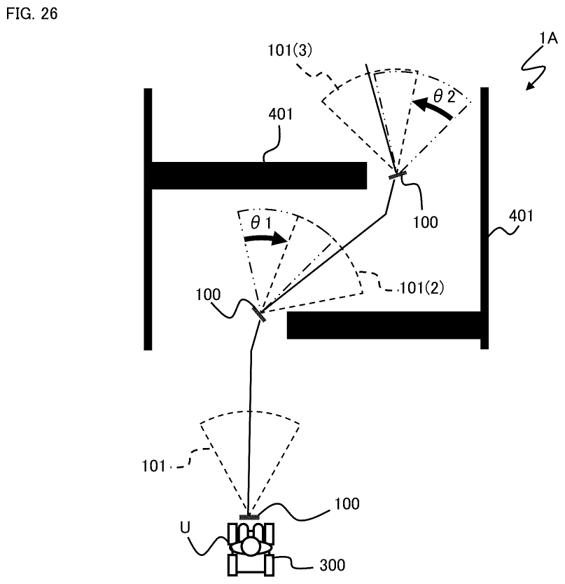

FIG. 26 schematically illustrates in plan the manner in which a route to be followed by a particular mobile body can be shortened by orienting a sensor on the particular mobile body into a direction in which the particular mobile body is turned in a case where the viewing angle of the sensor is narrow.

As illustrated in FIG. 26, even if the sensor terminal 100 on the mobile body 300 includes a sensor having a narrow viewing angle, the mobile body 300 can travel along the same route and arrive at the destination at the same arrival time as a mobile body 300 in which the sensor terminal 100 includes a sensor having a wider viewing angle, if the user U cooperates to change the terminal posture.

As illustrated in a central region of FIG. 26, when the mobile body 300 is to turn to the right, the user U cooperates to turn the sensor terminal 100 to the right through an angle θ1, shifting the detection range 101(2) to the right. Thus, when the mobile body 300 is to turn to the right, the sensor terminal 100 can quickly detect a situation behind a wall.

As illustrated in an upper region of FIG. 26, when the mobile body 300 is to turn to the left, the user U cooperates to turn the sensor terminal 100 to the left through an angle θ2, shifting the detection range 101(3) to the left. Thus, when the mobile body 300 is to turn to the left, the sensor terminal 100 can quickly detect a situation behind another wall.

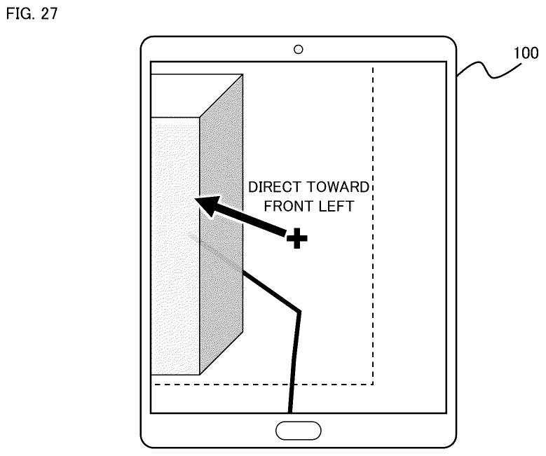

FIG. 27 illustrates the manner in which the user U is instructed which direction the sensor terminal 100 is to be oriented in. As illustrated in FIG. 27, a message “DIRECT TOWARD FRONT LEFT,” for example, is displayed together with an arrow to guide the user U to change the direction of the sensor terminal 100.

The second embodiment described above offers the same advantages as the first embodiment. According to the second embodiment, in addition, since the user U is instructed to change the posture (and the position, if desired) of the sensor terminal 100 depending on how the mobile body 300 is traveling, the sensor terminal 100 that includes a sensor having a narrow viewing angle can be used as a sensor terminal 100 that includes a sensor having a wider viewing angle. Consequently, even when the user U carries a sensor terminal 100 having poor technical specifications, the mobile body 300 can travel autonomously along a short route to the destination with safety. The user U with the sensor terminal 100 having the poor technical specifications can thus use the travel control system 1A to its full potential.

### Third Embodiment

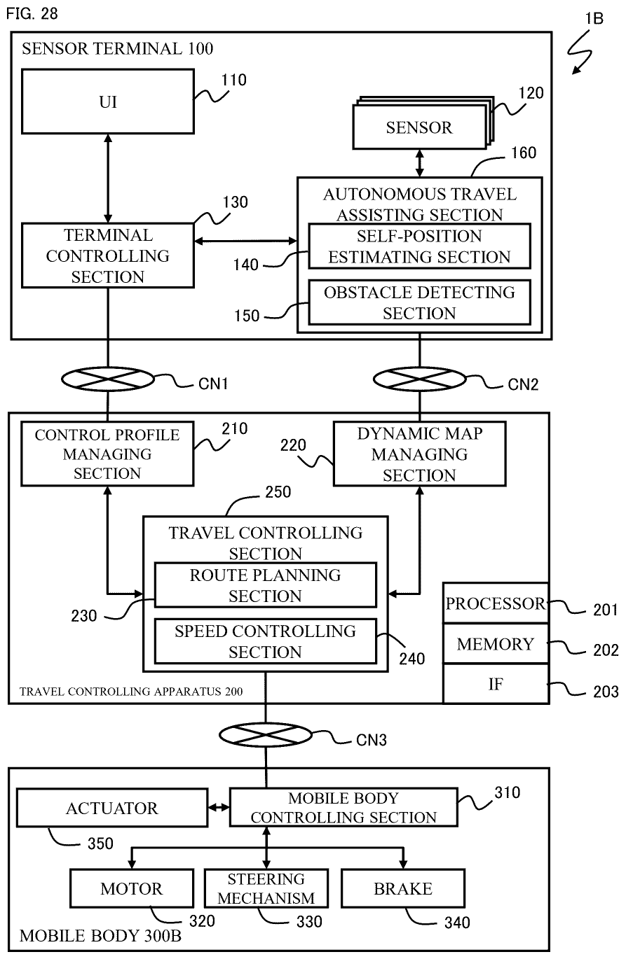

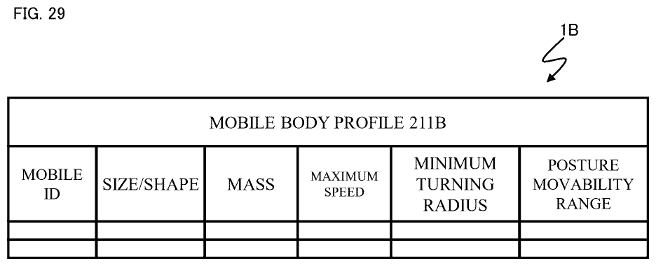

A third embodiment of the present invention will be described below with reference to FIGS. 28 and 29. A travel control system 1B according to the third embodiment includes an actuator 350 such as a robot arm, for example, provided on a mobile body 300B.

FIG. 28 illustrates the travel control system 1B in block form.

The sensor terminal 100 can be installed on the mobile body 300B. The actuator 350 is able to automatically adjust the position (and the position, if desired) of the installed sensor terminal 100. The actuator 350 may be configured as a robot arm or an electric motor and a cylinder or a solenoid, for example.

When the user U gets on the mobile body 300B, the user U mounts the sensor terminal 100 that the user U is carrying on the actuator 350. The actuator 350 is operated to change the posture of the sensor terminal 100 according to an instruction from the travel controlling apparatus 200.

FIG. 29 illustrates a mobile body profile 211B according to the third embodiment. The mobile body profile 211B stores a posture movability range for the actuator 350 on the mobile body 300B. The travel controlling apparatus 200 eases the constraint on the turning radiuses at the time it plans a route 102 on the basis of the posture movability range for the actuator 350 and the viewing angle of the sensor 120.

According to an instruction from the travel controlling apparatus 200, the actuator 350 is operated to change the posture of the sensor terminal 100 to a direction represented by the instruction.

The third embodiment described above offers the same advantages as the first and second embodiments. According to the third embodiment, in addition, since the actuator 350 on the mobile body 300B adjusts the posture of the sensor terminal 100, the mobile body 300 can travel autonomously along a short route with safety regardless of whether the user U cooperates or not. Moreover, as the user U on the mobile body 300B is not required to carry the sensor terminal 100 by hand, the user U finds it convenient to use its hands freely as desired.

Moreover, the posture movability range for the actuator 350 is registered in advance in the mobile body profile 211B. Accordingly, even if any one of actuators 350 having different technical specifications is used on the mobile body 300B, the actuator 350 is able to adjust the posture of the sensor terminal 100.

### Fourth Embodiment

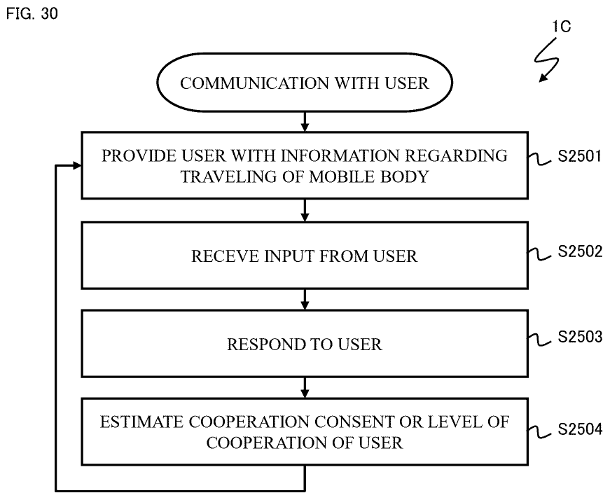

A fourth embodiment of the present invention will be described below with reference to FIG. 30. FIG. 30 is a flowchart of a process of performing communication with the user U according to the fourth embodiment. A travel control system 1C according to the fourth embodiment estimates cooperation consent or a level of cooperation of the user U via communication with the user U.

The travel controlling apparatus 200 of the travel control system 1C provides the user U with various items of information regarding traveling of the mobile body 300 (S2501). The various items of information regarding traveling of the mobile body 300 represent such messages as “DESTINATION IS. IT WILL TAKE APPROXIMATELY 7 MINUTES UNTIL ARRIVAL AT DESTINATION,” “DIRECT YOUR SENSOR TERMINAL TO DIRECTION INDICATED BY ARROW,” “CLOSER ROUTE FOUND. DO YOU WANT TO CHANGE TO IT?” and “LOCAL SPECIALTY IN THIS AREA IS ***. DO YOU WANT TO VISIT SOUVENIR SHOP?” The various items of information may be provided to the user U with use of what is generally called generative artificial intelligence (AI).

The travel controlling apparatus 200 receives an input from the user U if necessary (S2502) and responds to the user U (S2503). The travel controlling apparatus 200 enters information input from the user U into a machine learning model that has been trained to estimate cooperation consent and a level of cooperation of the user U and estimates cooperation consent and a level of cooperation of the user U (S2504). The estimated cooperation consent and the estimated level of cooperation will be used to ease control constraints at the time when a route is planned.

The fourth embodiment described above offers the same advantages as the first, second, and third embodiments. According to the fourth embodiment, in addition, since the cooperation consent or level of cooperation of the user U can be estimated through an interaction with the user U regarding the traveling of the mobile body 300, the user U finds it more convenient than if the user U inputs the cooperation consent or level of cooperation by him/herself.

### Fifth Embodiment

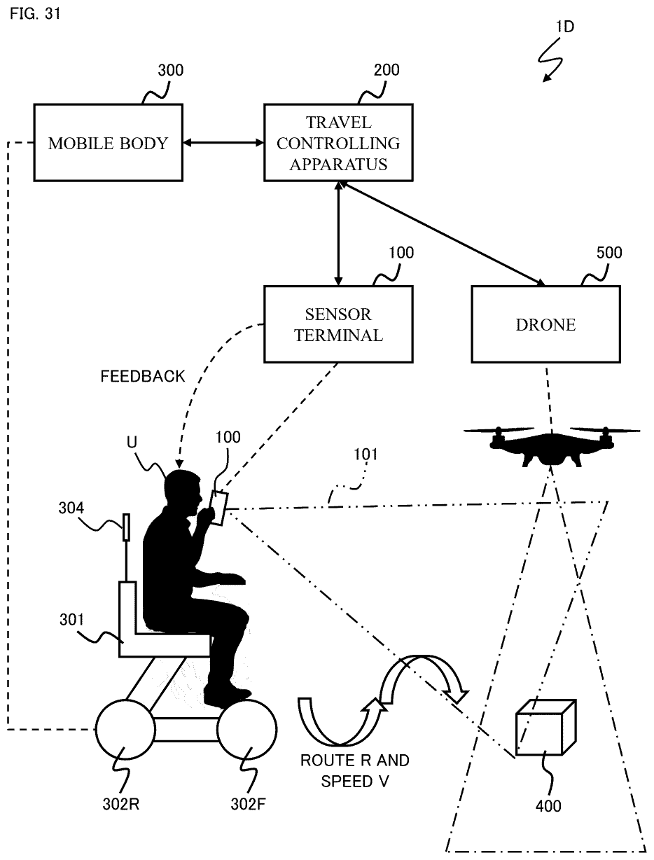

A fifth embodiment of the present invention will be described below with reference to FIG. 31. FIG. 31 schematically illustrates, partly in block form, a travel control system 1D according to the fifth embodiment.

According to the fifth embodiment, the travel control system 1D includes a drone 500 with a sensor for detecting an object 400 on the route in addition to the sensor terminal 100 carried by the user U. The drone 500 is parked at a station for distributing mobile bodies 300 and is selected by the user U. The selected drone 500 flies over the route prior to the mobile body 300 and the sensor such as a camera of the drone 500 detects the object 400 on the route. The drone 500 transmits data of the detected object 400 to the sensor terminal 100 by way of short-distance communication, for example. The autonomous travel assisting section 160 of the sensor terminal 100 estimates the self-position of the mobile body 300 and the object 400 on the basis of the data from the sensors 120 of the sensor terminal 100 and the data from the sensor of the drone 500.

The drone 500 and the mobile body 300 may be held in a one-to-one correspondence or the drone 500 may be associated with a plurality of mobile bodies 300. One or more drones 500 may fly within the predetermined range, and information obtained by the sensor of the drone 500 or the sensors of the drones 500 may be transmitted to the travel controlling apparatus 200, after which the dynamic map information 221 updated by the travel controlling apparatus 200 may be shared by the sensor terminals 100 associated with respective mobile bodies 300.

The fifth embodiment described above offers the same advantages as the first embodiment. According to the fifth embodiment, in addition, since the drone 500 used in addition to the sensor terminal 100 carried by the user U is used as sensing means, the travel control system 1D has an increased detecting capability.

### Sixth Embodiment

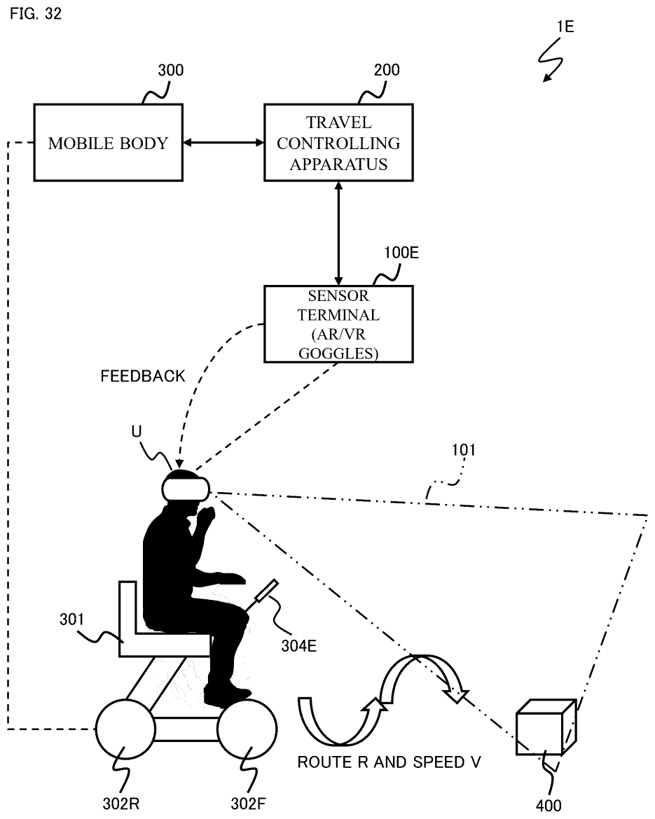

A sixth embodiment of the present invention will be described below with reference to FIG. 32. FIG. 32 illustrates a travel control system 1E that uses AR/VR goggles 100E as a sensor terminal. The AR/VR goggles 100E represent a goggles-shaped information processing terminal that can be used in an AR environment and a VR environment.

As described above, the travel control system 1E according to the present embodiment uses the AR/VR goggles 100E as a sensor terminal. The AR/VR goggles 100E include a display, speakers, a microphone, and various sensors, for example. The various sensors include a camera and a gyro sensor. A marker 304E is installed in a position where the camera of the AR/VR goggles 100E can capture an image of the marker 304E.

The sixth embodiment described above offers the same advantages as the first embodiment. The AR/VR goggles 100E may be made available at a station for distributing mobile bodies 300 or the reception of a facility.

### Seventh Embodiment

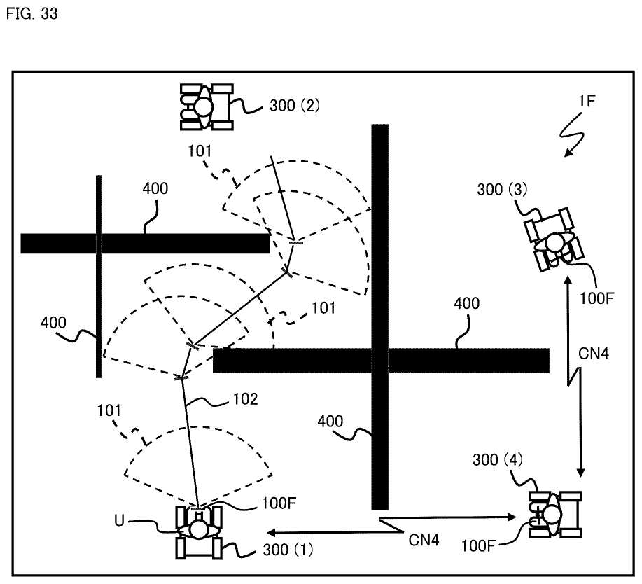

A seventh embodiment of the present invention will be described below with reference to FIGS. 33 through 35. FIG. 33 illustrates in plan the manner in which a particular mobile body 300 performs self-position estimation while exchanging data detected by sensors with a near particular mobile body 300.

A travel control system 1F according to the seventh embodiment includes a plurality of, e.g., four, mobile bodies 300 traveling in a predetermined range. Of all sensor terminals 100F on the mobile bodies 300, the sensor terminal 100F on the mobile body 300(1) and the sensor terminal 100F on the mobile body 300(4) are exchanging data detected by their sensors 120 by way of short-distance communication CN4. Similarly, the sensor terminal 100F on the mobile body 300(3) and the sensor terminal 100F on the mobile body 300(4) are also exchanging data detected by their sensors 120 by way of short-distance communication CN4.

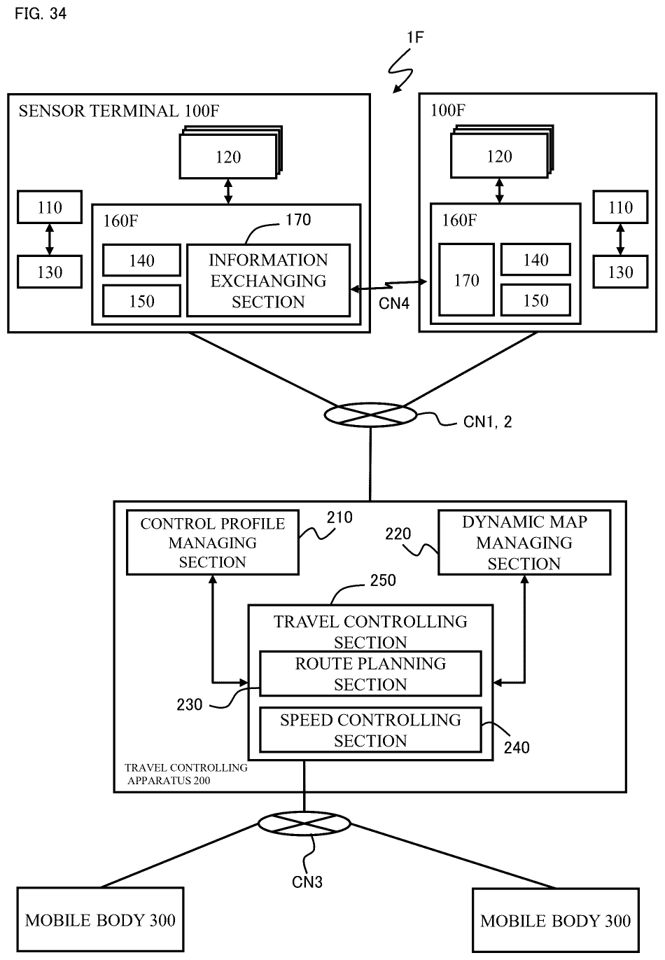

FIG. 34 illustrates the travel control system 1F in block form. Each of the sensor terminals 100F has an autonomous travel assisting section 160F that includes an information exchanging section 170 for exchanging information with a nearby mobile body 300. The information exchanging section 170 exchanges data detected by the sensors 120 with the information exchanging section 170 of another sensor terminal 100F by way of short-distance communication CN4.

The autonomous travel assisting section 160F estimates a self-position and detects the position, shape, and size of an object 400 by using not only data detected by the sensors 120 of its own sensor terminal 100F but also data detected by the sensors 120 of another sensor terminal 100F. Data exchanged with a nearby sensor terminal 100F may be raw data output from the sensors or processed data that has been processed by a statistic process, for example.

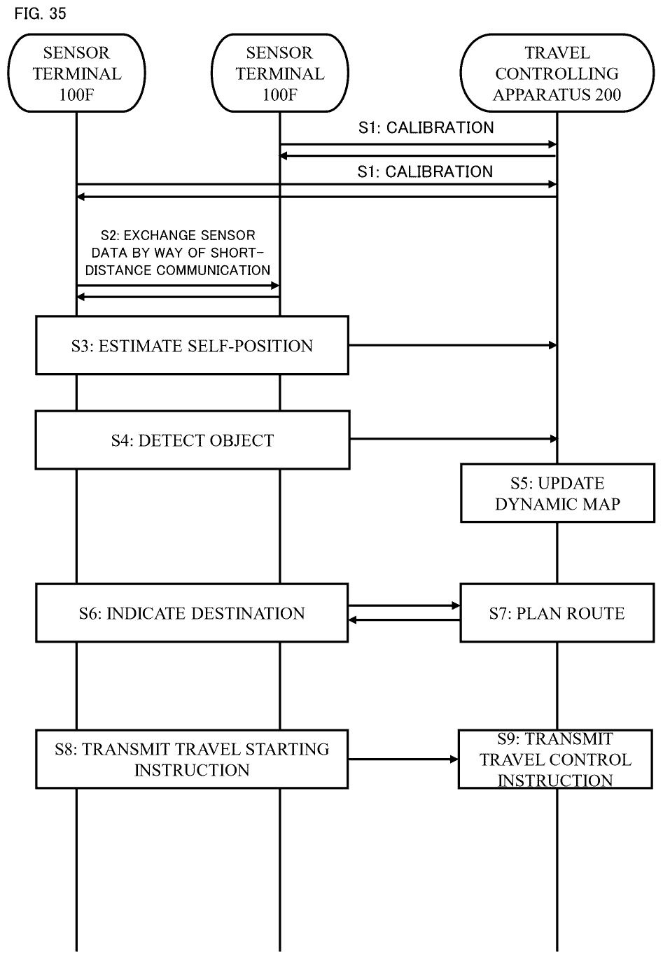

FIG. 35 illustrates a process of exchanging data detected by sensors 120 between nearby particular mobile bodies 300 and transmitting information regarding calculated self-positions and obstacles to the travel controlling apparatus 200. The process is illustrated as simplified in its entirety in FIG. 35.

Each sensor terminal 100F carries out a calibration process in coaction with the travel controlling apparatus 200 (S1). Sensor terminals 100F that are positioned in a range capable of short-distance communication CN4 exchange data detected by their sensors 120 by way of short-distance communication CN4 (S2).

Each sensor terminal 100F estimates a self-position (S3) and detects an object (S4) as an obstacle by using not only data detected by its own sensors 120 but also data detected by the sensors 120 of another sensor terminal 100F. Information regarding the estimated self-position and the detected object is transmitted to the travel controlling apparatus 200 via communication networks CN1 and CN2.

The travel controlling apparatus 200 updates the dynamic map information 221 on the basis of the information from each sensor terminal 100F (S5). When a destination is indicated by each sensor terminal 100F (S6), the travel controlling apparatus 200 plans a route 102 (S7). When a travel starting instruction from the user U is transmitted from each sensor terminal 100F (S8), the travel controlling apparatus 200 transmits a travel controlling instruction to each mobile body 300 (S9). For illustrative purposes, the processing in each of steps S3 through S9 at each sensor terminal 100F is indicated as a single process. The processing after the travel controlling instruction has been transmitted to each mobile body 300 is omitted from illustration.

The seventh embodiment described above offers the same advantages as the first embodiment. According to the seventh embodiment, moreover, raw data from the sensors 120 are exchanged between the sensor terminals 100F by way of the short-distance communication CN4, and secondary information such as estimated self-position information and detected object information based on the raw data from the sensors 120 is transmitted to the travel controlling apparatus 200 via the communication networks CN1 and CN2 that have a longer communication range than the short-distance communication CN4. Hence, more pieces of sensor data can be exchanged between the sensor terminals 100F without wasting the communication bands of the communication networks CN1 and CN2.

### Eighth Embodiment

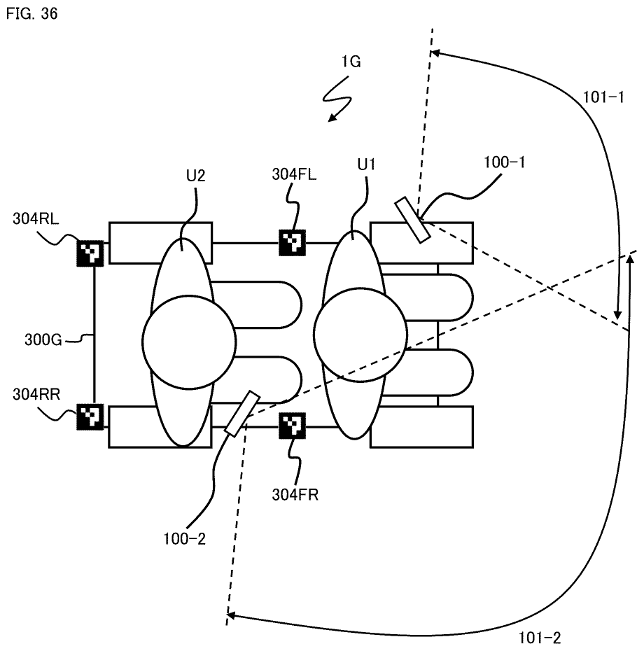

An eighth embodiment of the present invention will be described below with reference to FIG. 36. FIG. 36 schematically illustrates in plan the manner in which a two-seater particular mobile body 300G increases its detection range by orienting sensor terminals 100-1 and 100-2 carried by front and rear users U1 and U2 on the two-seater particular mobile body 300G in different directions.

The mobile body 300G is a two-seater particular mobile body on which the front and rear users U1 and U2 are riding in tandem. The sensor terminal 100-1 carried by the front user U1 is oriented to the left as viewed from the front user U1 facing in the direction along which the mobile body 300G travels forward, whereas the sensor terminal 100-2 carried by the rear user U2 is oriented to the right as viewed from the rear user U2 facing in the direction along which the mobile body 300G travels forward. Yet, the sensor terminal 100-1 carried by the front user U1 may be oriented to the right, and the sensor terminal 100-2 carried by the rear user U2 may be oriented to the left.

Markers 304FL and 304FR are mounted on respective left and right sides of a central portion of the mobile body 300G. Markers 304RL and 304RR are mounted on respective left and right sides of a rear portion of the mobile body 300G.

The front sensor terminal 100-1 positions itself with respect to the mobile body 300G with use of either one of the markers 304FL and 304FR. The rear sensor terminal 100-2 positions itself with respect to the mobile body 300G with use of either one of the markers 304RL and 304RR.

In the figure, the sensor of the front sensor terminal 100-1 has a detection range 101-1 spreading forward to the left of the mobile body 300G. The sensor of the rear sensor terminal 100-2 has a detection range 101-2 spreading forward to the right of the mobile body 300G.

Each of the sensor terminals 100-1 and 100-2 estimates its self-position from the data detected by its sensors and detects an object on a route followed by the mobile body 300G. Information regarding the estimated self-position and the detected object is transmitted to the travel controlling apparatus 200, as in the first embodiment.

The eighth embodiment described above offers the same advantages as the first embodiment. According to the eighth embodiment, moreover, since the sensor terminals 100-1 and 100-2 carried by the respective users U1 and U2 on the two-seater mobile body 300G are oriented in different directions, the sensor terminals 100-1 and 100-2 provide a wider joint detection range for simultaneously detecting objects than the sensor terminal 100 according to the first embodiment. Thus, the travel control system 1G according to the eighth embodiment can control the mobile body 300G to travel autonomously along a short route with safety. The sensor terminals 100-1 and 100-2 may be held by front and rear actuators mounted on the mobile body 300G, to be controlled in posture by the respective actuators.

The present invention is not limited to the embodiments described above, and covers various modifications of the embodiments. The embodiments have been described in detail for easier understanding of the present invention, and not all of the details of the embodiments should be interpreted as indispensable elements of the present invention. The configurations, functions, processing sections, and processing means described above may be hardware-implemented by integrated circuits (ICs), for example. Alternatively, the configurations, functions, and processing sections described above may be software-implemented by processors as they interpret and execute programs. Such information as programs, tables, and files may be stored in recording devices including a memory, a hard disk, and a solid-state drive (SSD), for example, or recording mediums including an IC card, a secure digital (SD) card, and a digital versatile disc (DVD), for example.

The present disclosure described above includes at least the following modes of invention.

### (Supplement 1)

A travel control system for a particular mobile body for controlling traveling of the particular mobile body that moves in a predetermined range while carrying at least one user, including a sensor terminal removably provided on the particular mobile body, the sensor terminal having a sensor for detecting an object on a route to be followed by the particular mobile body, and a travel controlling apparatus communicably connected to the sensor terminal for generating a travel controlling instruction for moving the particular mobile body to a predetermined location, on the basis of predetermined information including data detected by the sensor and received from the sensor terminal, and inputting the generated travel controlling instruction to the particular mobile body.

### (Supplement 2)

The travel control system for a particular mobile body according to supplement 1, in which the sensor terminal is selected from a group of sensor terminals having different technical specifications, and the predetermined information includes technical specifications of the sensor terminal and the data detected by the sensor.

### (Supplement 3)

The travel control system for a particular mobile body according to supplement 1 or 2, in which the technical specifications of the sensor terminal include information concerning a viewing angle and a detection distance of the sensor.

### (Supplement 4)

The travel control system for a particular mobile body according to any one of supplements 1 through 3, in which the travel controlling instruction includes a route along which the particular mobile body is to move to the predetermined location and a speed at which the particular mobile body is to move.

### (Supplement 5)

The travel control system for a particular mobile body according to any one of supplements 1 through 4, in which the travel controlling instruction includes a turning radius of the particular mobile body as well as the route and the speed.

### (Supplement 6)

The travel control system for a particular mobile body according to any one of supplements 1 through 5, in which the sensor terminal is a portable information terminal held by the user.

### (Supplement 7)

The travel control system for a particular mobile body according to any one of supplements 1 through 6, in which the travel controlling apparatus notifies the user of a predetermined instruction with respect to a position and a posture of the sensor terminal through the sensor terminal.

### (Supplement 8)

The travel control system for a particular mobile body according to any one of supplements 1 through 7, in which the travel controlling apparatus calculates a possibility that the user will follow the predetermined instruction and corrects the travel controlling instruction depending on the calculated possibility.

### (Supplement 9)

The travel control system for a particular mobile body according to any one of supplements 1 through 8, further including a dynamic map managing section for generating and updating a map of the predetermined range on the basis of the predetermined information.

### (Supplement 10)

The travel control system for a particular mobile body according to any one of supplements 1 through 9, in which the predetermined information includes technical specifications of the sensor terminal and the data detected by the sensor, and the data detected by the sensor includes positional information of the sensor terminal and information concerning the object detected by the sensor.

### (Supplement 11)

The travel control system for a particular mobile body according to any one of supplements 1 through 10, in which the sensor terminal exchanges data detected by the sensor with another sensor terminal, calculates positional information of the sensor terminal and information concerning the object on the basis of the data detected by the sensor of the sensor terminal and data detected by another sensor of the other sensor terminal, and transmits the calculated positional information and the information concerning the object as part of the predetermined information to the travel controlling apparatus.

### (Supplement 12)

The travel control system for a particular mobile body according to any one of supplements 1 through 11, in which, in a case where a plurality of users are carried by the particular mobile body, the sensor terminals carried by respective users are oriented in respective different directions on the basis of predetermined feedback information transmitted from the travel controlling apparatus to the users.

### (Supplement 13)

The travel control system for a particular mobile body according to any one of supplements 1 through 12, in which the predetermined range lies in a predetermined facility, and the particular mobile body travels on a floor shared by pedestrians walking in the predetermined facility.

### (Supplement 14)

A travel control method for a particular mobile body of making a travel controlling apparatus control traveling of the particular mobile body that moves in a predetermined range while carrying at least one user, the travel controlling apparatus being communicably connected to a sensor terminal removably provided on the particular mobile body, and the sensor terminal having a sensor for detecting an object on a route to be followed by the particular mobile body, the travel control method including, by the travel controlling apparatus, a step of generating a travel controlling instruction for moving the particular mobile body to a predetermined location on the basis of predetermined information including data detected by the sensor and received from the sensor terminal, and a step of inputting the generated travel controlling instruction to the particular mobile body.

### (Supplement 15)

The travel control method for a particular mobile body according to supplement 14, in which, after the step of inputting the generated travel controlling instruction to the particular mobile body, a step of notifying the user of a predetermined instruction with respect to a position and a posture of the sensor terminal from the sensor terminal is further performed.

What is claimed is:

1. A travel control system for a particular mobile body for controlling traveling of the particular mobile body that moves in a predetermined range while carrying at least one user, comprising:
a sensor terminal removably provided on the particular mobile body, the sensor terminal having a sensor for detecting an object on a route to be followed by the particular mobile body; and
a travel controlling apparatus communicably connected to the sensor terminal for generating a travel controlling instruction for moving the particular mobile body to a predetermined location, on a basis of predetermined information including data detected by the sensor and received from the sensor terminal, and inputting the generated travel controlling instruction to the particular mobile body.

2. The travel control system for a particular mobile body according to claim 1, wherein the sensor terminal is selected from a group of sensor terminals having different technical specifications, and
the predetermined information includes technical specifications of the sensor terminal and the data detected by the sensor.

3. The travel control system for a particular mobile body according to claim 2, wherein the technical specifications of the sensor terminal include information concerning a viewing angle and a detection distance of the sensor.

4. The travel control system for a particular mobile body according to claim 3, wherein the travel controlling instruction includes a route along which the particular mobile body is to move to the predetermined location and a speed at which the particular mobile body is to move.

5. The travel control system for a particular mobile body according to claim 4, wherein the travel controlling instruction includes a turning radius of the particular mobile body as well as the route and the speed.

6. The travel control system for a particular mobile body according to claim 5, wherein the sensor terminal is a portable information terminal held by the user.

7. The travel control system for a particular mobile body according to claim 6, wherein the travel controlling apparatus notifies the user of a predetermined instruction with respect to a position and a posture of the sensor terminal through the sensor terminal.

8. The travel control system for a particular mobile body according to claim 7, wherein the travel controlling apparatus calculates a possibility that the user will follow the predetermined instruction and corrects the travel controlling instruction depending on the calculated possibility.

9. The travel control system for a particular mobile body according to claim 1, further comprising:
a dynamic map managing section for generating and updating a map of the predetermined range on a basis of the predetermined information.

10. The travel control system for a particular mobile body according to claim 2, wherein the data detected by the sensor includes positional information of the sensor terminal and information concerning the object detected by the sensor.

11. The travel control system for a particular mobile body according to claim 2, wherein the sensor terminal exchanges data detected by the sensor with another sensor terminal, calculates positional information of the sensor terminal and information concerning the object on a basis of the data detected by the sensor of the sensor terminal and data detected by another sensor of the other sensor terminal, and transmits the calculated positional information and the information concerning the object as part of the predetermined information to the travel controlling apparatus.

12. The travel control system for a particular mobile body according to claim 7, wherein, in a case where a plurality of users are carried by the particular mobile body, the sensor terminals carried by respective users are oriented in respective different directions on a basis of predetermined feedback information transmitted from the travel controlling apparatus to the users.

13. The travel control system for a particular mobile body according to claim 1, wherein the predetermined range lies in a predetermined facility, and
the particular mobile body travels on a floor shared by pedestrians walking in the predetermined facility.

14. A travel control method for a particular mobile body of making a travel controlling apparatus control traveling of the particular mobile body that moves in a predetermined range while carrying at least one user, the travel controlling apparatus being communicably connected to a sensor terminal removably provided on the particular mobile body, and the sensor terminal having a sensor for detecting an object on a route to be followed by the particular mobile body, the travel control method comprising:
by the travel controlling apparatus,
a step of generating a travel controlling instruction for moving the particular mobile body to a predetermined location on a basis of predetermined information including data detected by the sensor and received from the sensor terminal; and
a step of inputting the generated travel controlling instruction to the particular mobile body.

15. The travel control method for a particular mobile body according to claim 14, wherein, after the step of inputting the generated travel controlling instruction to the particular mobile body, a step of notifying the user of a predetermined instruction with respect to a position and a posture of the sensor terminal from the sensor terminal is further performed.
